(19) United States
(12) Patent Application Publication
(10) Pub. No.: US 2026/0366555 A1
(43) Pub. Date: Nov. 19, 2026

(54) STRUCTURAL SUPPORT DESIGN SYSTEM

(71) Applicant: Jason Mathew Jennings, Baton Rouge, LA (US)

(72) Inventor: Jason Mathew Jennings, Baton Rouge, LA (US)

(21) Appl. No.: 19/132,076

(22) PCT Filed: Apr. 7, 2023
(86) PCT No.: PCT/US23/17834

§ 371 Date: May 22, 2025

(51) Int. Cl. F16B 12/26; F16B 12/44

(52) U.S. Cl. CPC F16B 12/26; F16B 2012/446

(57) ABSTRACT

The invention is a structural support design system. It comprises a plan for a structural design and reconnectable structural support pieces that allow it to be rapidly assembled and disassembled. The disassembly of the pieces, in particular, can occur all at once due to the structural pieces being able to be set in a locked open state. After being set in this state, the pieces can be quickly pulled apart from one another, stored and are ready to be used again with no intervention.

### TECHNICAL FIELD

This invention is in the technical field of structural support, structural design, and modular design furniture.

### BACKGROUND ART

There are numerous ways to connect pre assembled furniture by a person for an end user. However, often the ways to attach pieces of furniture to each other are permanent. When the attachment means is not permanent it is often very time consuming to both assemble and disassemble the furniture. What is needed is a structural support design system that allows one to rapidly piece together pre designed structures, such as furniture. What is also needed is a system for rapidly disassembling such pre-designed structures in a manner that is quick and efficient, but after disassembly, the predesigned structures are ready to be re-assembled without intervention.

### SUMMARY OF INVENTION

The invention is a structural support design system. It comprises a plan for a structural design and reconnectable structural support pieces that allow it to be rapidly assembled and disassembled. The disassembly of the pieces, in particular, can occur all at once due to the structural pieces being able to be set in a locked open state. After being set in this state, the pieces can be quickly pulled apart from one another, stored and are ready to be used again with no intervention.

### TECHNICAL PROBLEM

What is needed is a structural support design system that allows one to rapidly piece together pre designed structures, such as furniture. What is also needed is a system for rapidly disassembling such pre-designed structures in a manner that is quick and efficient, but after disassembly, the predesigned structures are ready to be re-assembled without intervention.

### BRIEF DESCRIPTION OF DRAWINGS

FIG. 1 illustrates a perspective view that shows components created by the various manufacturing systems, where each lead line indicates an individual manufacturing process which results in the component (arrow), according to an embodiment of the present disclosure.

FIG. 2 illustrates a perspective view that shows components created by the various manufacturing systems, where each lead line indicates an individual manufacturing process which results in the component (arrow), according to an embodiment of the present disclosure.

FIG. 3 illustrates a perspective view that shows consecutive assembly steps indicated by white arrows with assembly direction indicated by dark arrows and lead line arrows indicating the assembly process, according to an embodiment of the present disclosure.

FIG. 4 illustrates a perspective view that shows consecutive assembly steps indicated by white arrows with assembly direction indicated by dark arrows and lead line arrows indicating the assembly process, according to an embodiment of the present disclosure, according to an embodiment of the present disclosure.

FIG. 5 illustrates a perspective view that shows the component created by the manufacturing systems, where each lead line indicates an individual manufacturing process that results in the component (arrow) , according to an embodiment of the present disclosure.

FIG. 6 illustrates a perspective view that shows components created by the various manufacturing systems, where each lead line indicates an individual manufacturing process which results in the component (arrow) and consecutive assembly steps indicated by white arrows, according to an embodiment of the present disclosure.

FIG. 7 illustrates a perspective view that shows consecutive assembly steps indicated by white arrows with assembly direction indicated by dark arrows and lead line arrows indicating the assembly process, according to an embodiment of the present disclosure.

FIG. 8 illustrates a perspective view that shows consecutive assembly steps indicated by white arrows with assembly direction indicated by dark arrows and lead line arrows indicating the assembly process, according to an embodiment of the present disclosure.

FIG. 9 illustrates a perspective view that shows components created by the various manufacturing systems, where each lead line indicates an individual manufacturing process which results in the component (arrow) , according to an embodiment of the present disclosure.

FIG. 10 illustrates a perspective view that shows 6 beam systems and 1 cube system comprising 6 support pins and a cube wherein the support pins may attach to the cube on its perpendicular faces which may subsequently attach to one beam system per cube face, according to an embodiment of the present disclosure.

FIG. 11 illustrates a perspective view that shows 6 beam systems and 1 cube system comprising 6 support pins and a cube wherein the support pins may attach to the cube on its perpendicular faces which may subsequently attach to one beam system per cube face, according to an embodiment of the present disclosure.

FIG. 12 illustrates a perspective view that shows consecutive use steps indicated by dark arrows and lead line arrows indicating the specific functional requirements, according to an embodiment of the present disclosure.

FIG. 13 illustrates a perspective view that shows the directional use of components indicated by dark arrows, while lead lines with arrows indicate specific functional processes and the lead lines without arrows indicating the product design features required to complete the functional process, according to an embodiment of the present disclosure.

FIG. 14 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 15 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 16 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 17 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 18 illustrates a perspective view that shows that after inserting many beams into cubes a simple box representative of a simple furniture design, which is now ready for a user, according to an embodiment of the present disclosure.

FIG. 19 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 20 illustrates a perspective view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 21 illustrates a perspective view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 22 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 23 illustrates an exploded perspective view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

FIG. 24 illustrates a perspective view that shows general components and their design features, according to an embodiment of the present disclosure.

FIG. 25 illustrates a perspective view that shows general components and their design features, according to an embodiment of the present disclosure.

FIG. 26 illustrates a perspective view that shows the key and its design features, according to an embodiment of the present disclosure.

FIG. 27 illustrates a perspective view that shows the key and hook and its design features, according to an embodiment of the present disclosure.

FIG. 28 illustrates a perspective view that shows the beam and its design features, according to an embodiment of the present disclosure.

FIG. 29 illustrates a perspective view that shows the support and its design features, according to an embodiment of the present disclosure.

FIG. 30 illustrates a perspective view that shows the hook and its design features, according to an embodiment of the present disclosure.

FIG. 31 illustrates a perspective view that shows the release button and its design features, according to an embodiment of the present disclosure.

FIG. 32 illustrates a perspective view that shows the release button and its design features, according to an embodiment of the present disclosure.

FIG. 33 illustrates a perspective view that shows the locking clip and its design features, according to an embodiment of the present disclosure.

FIG. 34 illustrates a perspective view that shows a cube system and its design features, according to an embodiment of the present disclosure.

FIG. 35 is a method diagram which describes the manufacture according to embodiment of the present disclosure.

FIG. 36 is a method diagram which describes the locking sub assembly manufacturing system according to an embodiment of the present disclosure.

FIG. 37 is a method diagram which describes the locking sub assembly assembly system according to an embodiment of the present disclosure.

FIG. 38 is a method diagram which describes the beam assembly system according to an embodiment of the present disclosure.

FIG. 39 is a method diagram which describes the beam system manufacturing process according to an embodiment of the present disclosure.

FIG. 40 is a method diagram which describes the beam recess creation system according to an embodiment of the present disclosure.

FIG. 41 is a method diagram which describes the beam according to an embodiment of the present disclosure.

FIG. 42 is a method diagram which describes the use according to an embodiment of the present disclosure.

FIG. 43 is a method diagram which describes the furniture locking assembly system according to an embodiment of the present disclosure.

FIG. 44 is a method diagram which describes the locking system according to an embodiment of the present disclosure.

FIG. 45 is a method diagram which describes the unlocking of all furniture system according to an embodiment of the present disclosure.

FIG. 46 is a method diagram which describes the disassembly system according to an embodiment of the present disclosure.

### DESCRIPTION OF EMBODIMENTS

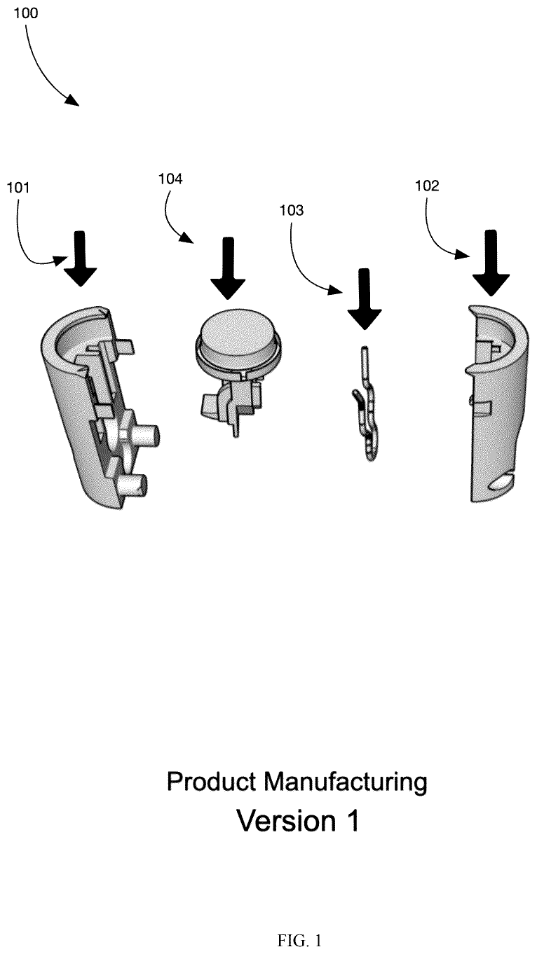

The present invention will now be described by referencing the appended figures representing embodiments of the invention. FIG. 1 illustrates a perspective view that shows components created by the various manufacturing systems, where each lead line indicates an individual manufacturing process which results in the component (arrow) , according to an embodiment of the present disclosure. In some embodiments, the locking sub assembly manufacturing system 100 may be configured to be consistently and rapidly manufactured and assembled. In some embodiments, the locking sub assembly manufacturing system 100 may be configured to produce the various components of the locking sub assembly 2404. In some embodiments, the locking sub assembly manufacturing system 100 is a mixture of 3D printing for the hook 2408, key 2405 and release button 2407 and order and purchase of a specially designed locking clip 2406 from a third party. In some embodiments, the locking sub assembly manufacturing system 100 may comprise key manufacturing system 101, hook manufacturing system 102, locking clip manufacturing system 103, release button manufacturing system 104 or sleeve manufacturing system 200. In some embodiments, the key manufacturing system 101 may be configured to be rapidly and consistently manufactured. In some embodiments, the key manufacturing system 101 utilizes 3D printing of a key 2405 Design from a 3D model. In some embodiments, the hook manufacturing system 102 may be configured to rapidly and consistently be manufactured. In some embodiments, the hook manufacturing system 102 utilizes 3D printing of the hook 2408 design from a 3D model. In some embodiments, the locking clip manufacturing system 103 may be configured to be rapidly and consistently manufactured. In some embodiments, the locking clip manufacturing system 103 may be done via order from a third party of the locking clip 2406 design. In some embodiments, the release button manufacturing system 104 may be configured to be rapidly and consistently manufactured. In some embodiments, the release button manufacturing system 104 utilizes 3D printing of the release button 2407 design based off a 3D model.

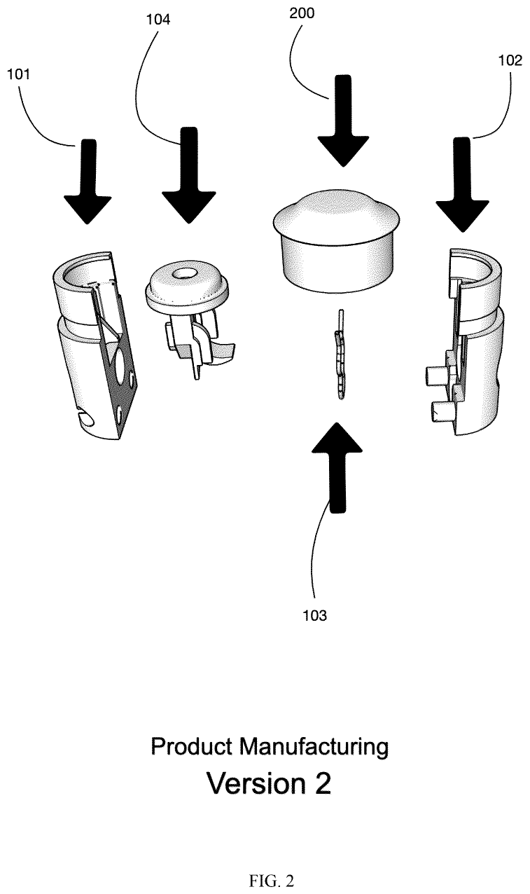

FIG. 2 illustrates a perspective view that shows components created by the various manufacturing systems, where each lead line indicates an individual manufacturing process which results in the component (arrow) , according to an embodiment of the present disclosure. In some embodiments, the sleeve manufacturing system 200 may be configured to manufacture a sleeve 2500.

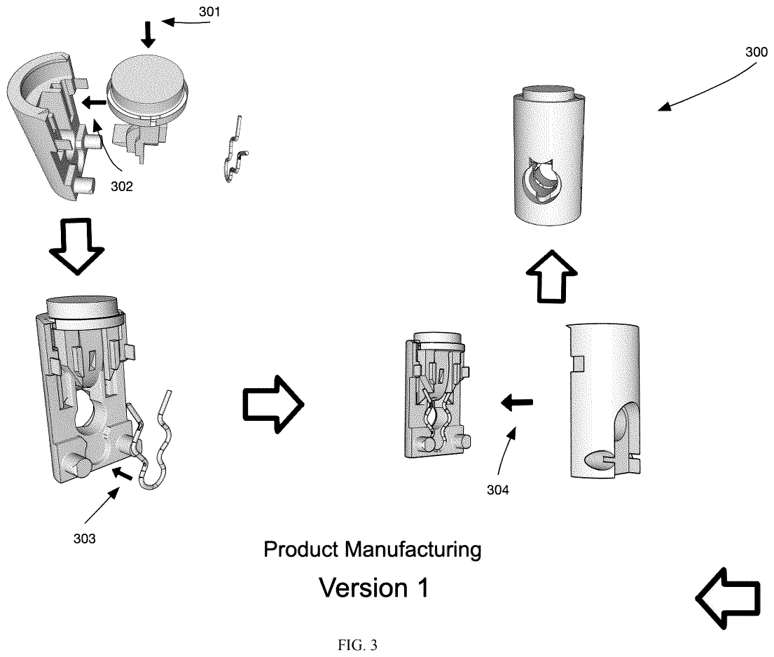

FIG. 3 illustrates a perspective view that shows consecutive assembly steps indicated by white arrows with assembly direction indicated by dark arrows and lead line arrows indicating the assembly process, according to an embodiment of the present disclosure. In some embodiments, the locking sub assembly assembly system 300 may be configured to assemble a plurality of components into the locking sub assembly 2404. In some embodiments, the locking sub assembly assembly system 300 can be done manually by a person assembling the components into a functional locking sub assembly 2404. In some embodiments, the locking sub assembly assembly system 300 may comprise locking sub assembly capping system 304, release button assembly positioning system 301, release button assembly insertion system 302, locking clip insertion system 303 or sleeve capping system 400. In some embodiments, the release button assembly positioning system 301 may be configured to position the release button 2407 so that the release button retaining circle 3107 is lateral to the key release button retaining channel 2608. In some embodiments, the release button assembly positioning system 301 can be done manually by hand if the locking sub assembly 2404 assembled by a person. In some embodiments, the release button assembly insertion system 302 may be configured to insert the release button 2407 so that the release button rear guide rail 3105 slides into the key release button guide channel 2605 and the release button hook arm 3100 slides into the key release button hook arm channel 2604 so that the release button retaining circle 3107 fits within the key release button retaining channel 2608 below the key release button retaining rim 2607 and onto the key release button retaining floor 2606. In some embodiments, the release button assembly insertion system 302 can be done manually by hand by resting the release button 2407 on the key release button retaining floor 2606 if the locking sub assembly 2404 is assembled by a person. In some embodiments, the locking clip insertion system 303 may be configured to insert the locking clip 2406 into the key locking clip foundation slot 2600. abutting the key face 2602 and below each release button locking clip guide face 3106. In some embodiments, the locking clip insertion system 303 can be done manually by hand. In some embodiments, the locking sub assembly capping system 304 may be configured to connect the key upper anchor 2603 pieces to each hook key upper anchor slot 3005 and connect the key lower anchor 2610 pieces to the hook lower anchor hole 3004. In some embodiments, the locking sub assembly capping system 304 can be done manually by hand.

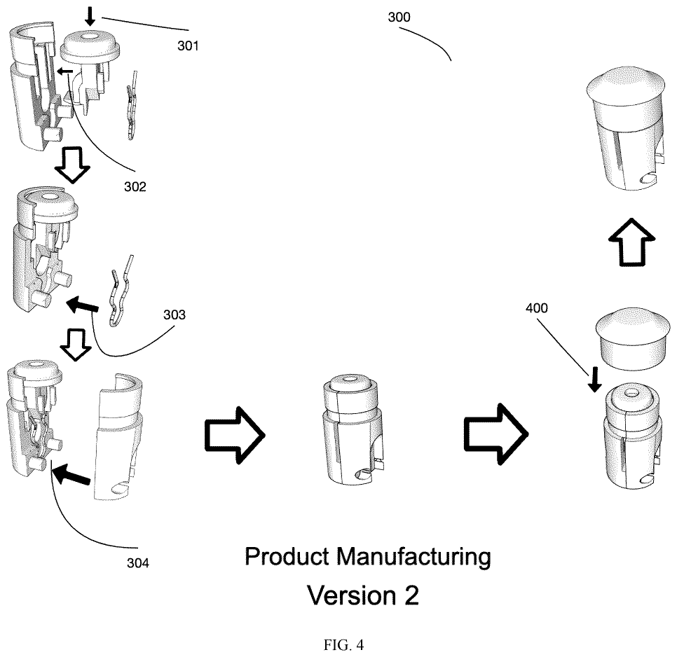

FIG. 4 illustrates a perspective view that shows consecutive assembly steps indicated by white arrows with assembly direction indicated by dark arrows and lead line arrows indicating the assembly process, according to an embodiment of the present disclosure, according to an embodiment of the present disclosure. In some embodiments, the sleeve capping system 400 may be configured to have the sleeve 2500 be placed over the locking sub assembly 2404 top portion, inserts on the release button insert recess 3201 and rests on the key sleeve receiving rim 2706 and hook sleeve receiving rim 2707.

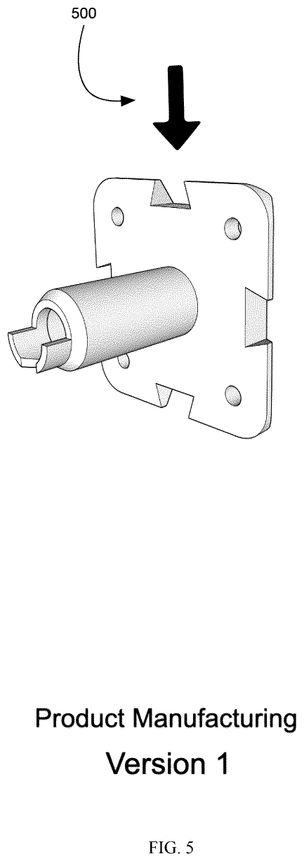

FIG. 5 illustrates a perspective view that shows the component created by the manufacturing systems, where each lead line indicates an individual manufacturing process that results in the component (arrow) , according to an embodiment of the present disclosure. In some embodiments, the support manufacturing system 500 may be configured to be rapidly and consistently manufactured. In some embodiments, the support manufacturing system 500 utilizes 3D printing of the support design based off a 3D model or be rapidly and consistently manufactured.

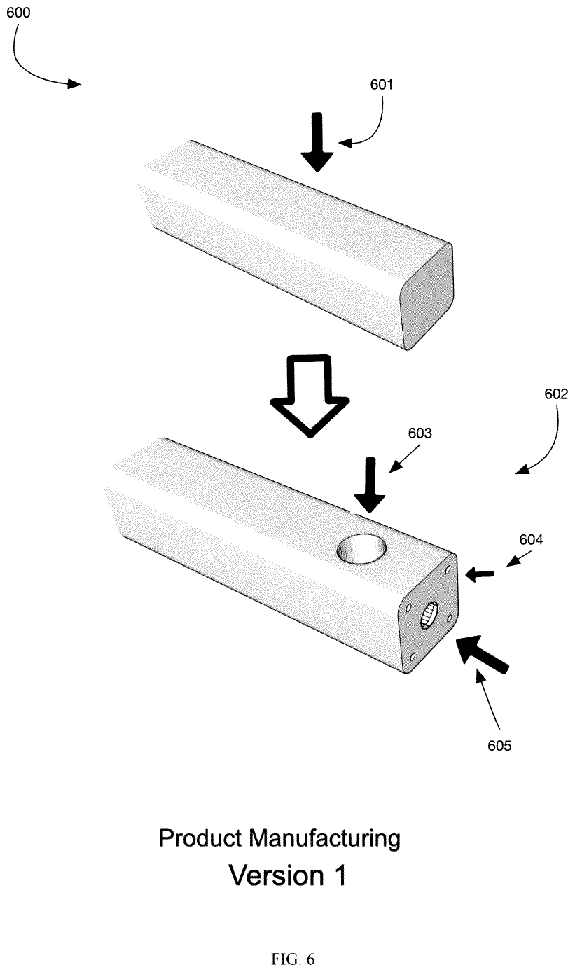

FIG. 6 illustrates a perspective view that shows components created by the various manufacturing systems, where each lead line indicates an individual manufacturing process which results in the component (arrow) and consecutive assembly steps indicated by white arrows, according to an embodiment of the present disclosure. In some embodiments, the beam system manufacturing process 600 may be configured to be rapidly and consistently manufactured and assembled. In some embodiments, the beam system manufacturing process 600 may comprise beam substrate manufacturing system 601 or beam recess creation system 602. In some embodiments, the beam substrate manufacturing system 601 may be configured to be rapidly and consistently manufactured. In some embodiments, the beam substrate manufacturing system 601 may contain the materials wood, plastic or composite. In some embodiments, the beam recess creation system 602 may be configured to create a plurality of recesses in the beam 2400 for housing and attaching components. In some embodiments, the beam recess creation system 602 can utilize drilling of holes with different size bits into the beam substrate. In some embodiments, the beam recess creation system 602 may comprise pilot hole creation system 604, locking sub assembly recess creation system 603 or support tube hole creation system 605. In some embodiments, the locking sub assembly recess creation system 603 may be configured to create a recess for the locking sub assembly 2404 in the beam 2400. In some embodiments, the locking sub assembly recess creation system 603 can utilize drilling of holes with a bit matched to the circumference and depth of the locking sub assembly 2404. In some embodiments, the pilot hole creation system 604 may be configured to create recesses for beam support anchor pilot hole 2801 for attaching the support 2401. In some embodiments, the pilot hole creation system 604 can utilize drilling of holes that create a recess or countersink for screws to attach the support 2401 to the beam 2400. In some embodiments, the support tube hole creation system 605 may be configured to create a recess, the beam support tube hole 2802 for receiving the support tube 2901. In some embodiments, the support tube hole creation system 605 can utilize drilling of holes with a bit matched to the circumference of the support tube 2901 and the depth of the support pin 2402 into the beam, when the cube 2403 is fully engaged with the support.

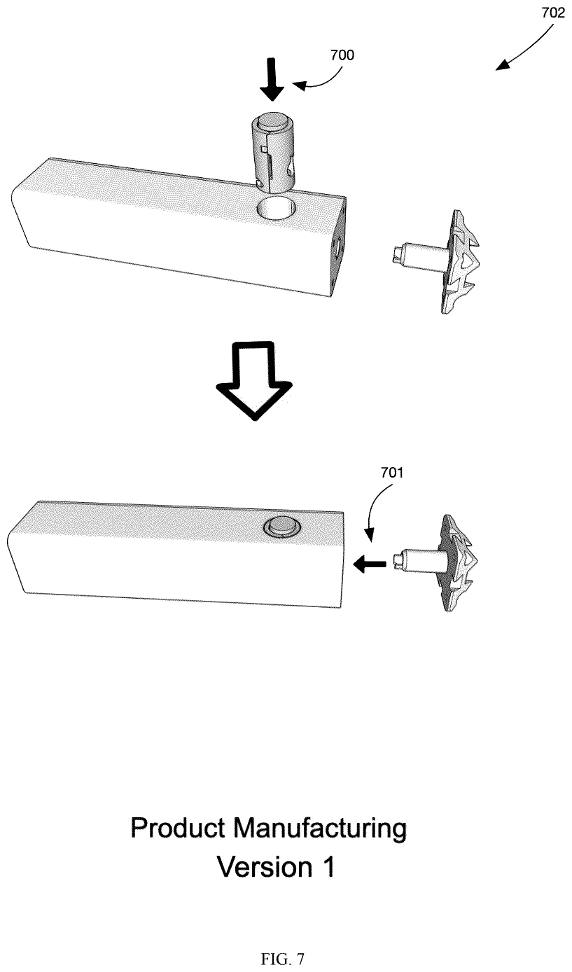

FIG. 7 illustrates a perspective view that shows consecutive assembly steps indicated by white arrows with assembly direction indicated by dark arrows and lead line arrows indicating the assembly process, according to an embodiment of the present disclosure. In some embodiments, the insert lock system 700 may be configured to insert the locking sub assembly 2404 into the beam locking sub assembly opening 2800. In some embodiments, the insert lock system 700 can be implemented manually by hand by pressing the locking sub assembly 2404 into the beam locking sub assembly opening 2800. In some embodiments, the attach support system 701 may be configured to insert the the support 2401 into the beam support tube hole 2802 and attach them through the beam support anchor pilot hole 2801. In some embodiments, the attach support system 701 can be implemented by manually screwing the support 2401 to the beam 2400 through the support anchor hole 2905 into the beam support anchor pilot hole 2801. In some embodiments, the beam assembly system 702 may be configured to be assembled rapidly and consistently. In some embodiments, the beam assembly system 702 may comprise insert lock system 700 or attach support system 701.

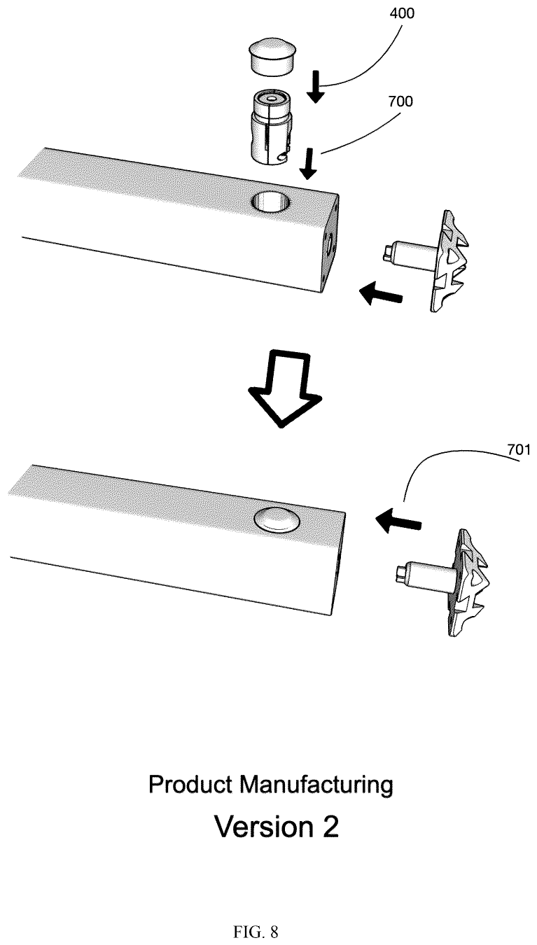

FIG. 8 illustrates a perspective view that shows consecutive assembly steps indicated by white arrows with assembly direction indicated by dark arrows and lead line arrows indicating the assembly process, according to an embodiment of the present disclosure.

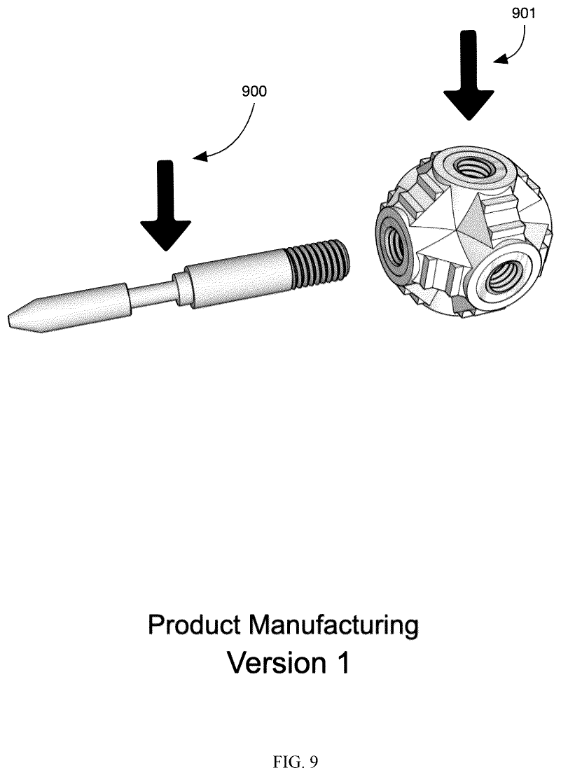

FIG. 9 illustrates a perspective view that shows components created by the various manufacturing systems, where each lead line indicates an individual manufacturing process which results in the component (arrow) , according to an embodiment of the present disclosure. In some embodiments, the support pin manufacturing system 900 may be configured to be rapidly and consistently manufactured. In some embodiments, the support pin manufacturing system 900 can be machined according to the design specification of the support pin 2402 or can be ordered from a third party supplier according to the design specification of the support pin 2402. In some embodiments, the cube manufacturing system 901 may be configured to be rapidly and consistently manufactured. In some embodiments, the cube manufacturing system 901 can be implemented by 3D printing of a cube 2403 design from a 3D model.

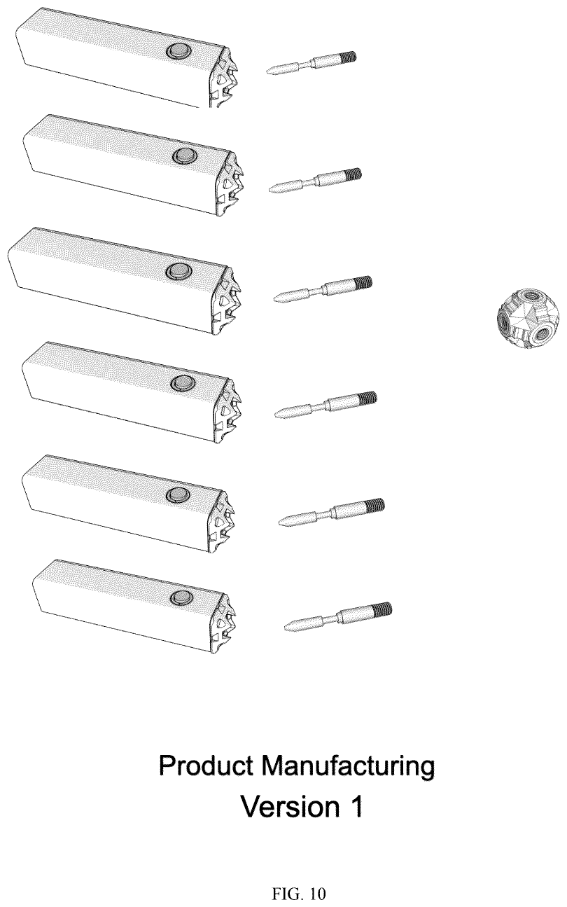

FIG. 10 illustrates a perspective view that shows 6 beam systems and 1 cube system comprising 6 support pins and a cube wherein the support pins may attach to the cube on its perpendicular faces which may subsequently attach to one beam system per cube face, according to an embodiment of the present disclosure.

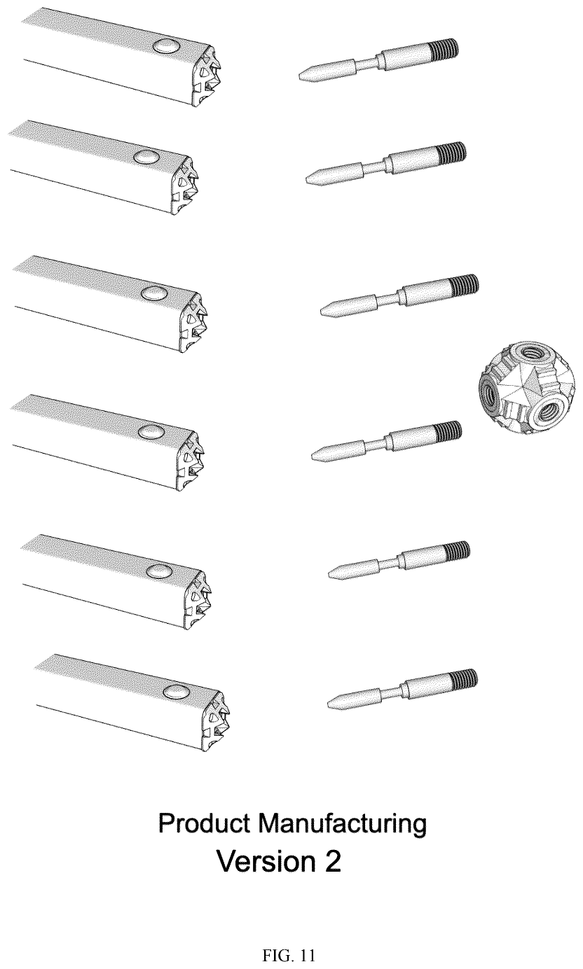

FIG. 11 illustrates a perspective view that shows 6 beam systems and 1 cube system comprising 6 support pins and a cube wherein the support pins may attach to the cube on its perpendicular faces which may subsequently attach to one beam system per cube face, according to an embodiment of the present disclosure.

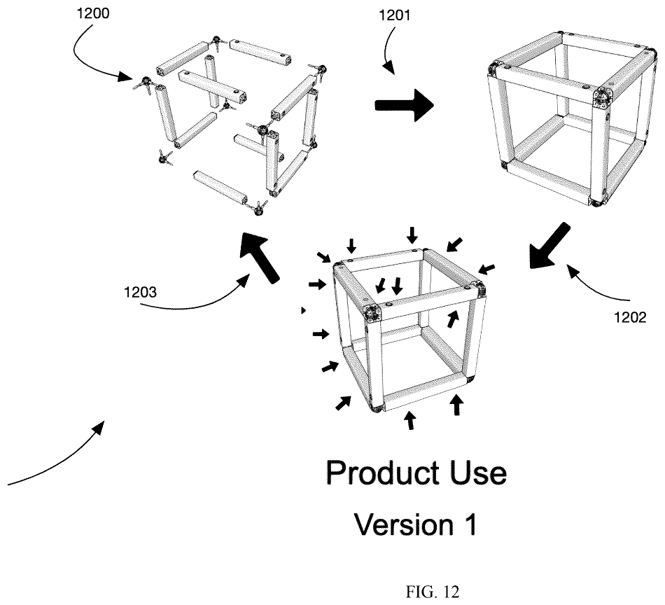

FIG. 12 illustrates a perspective view that shows consecutive use steps indicated by dark arrows and lead line arrows indicating the specific functional requirements, according to an embodiment of the present disclosure. In some embodiments, the prepare joint system 1200 may be configured to attach one or more support pin 2402 to cube 2403 via the support pin screw threads 3400 screwing into the cube hole 3411. In some embodiments, the furniture locking assembly system 1201 may be configured to assemble a plurality of beam systems 2409 and cube systems 2410 according to a furniture design. In some embodiments, the furniture locking assembly system 1201 may comprise cube orientation system 1400, pin insertion system 1401, release button reset system 1500, locking clip expansion system 1501 or locking system. In some embodiments, the unlock all furniture system 1202 may be configured to allow rapid disassembly of an assembled furniture design, by unlocking all beam systems 2409 prior to pulling them apart and disassembling, essentially unlocking everything at once. In some embodiments, the unlock all furniture system 1202 may comprise button press system 1900 or hook arm catch system 1901. In some embodiments, the disassembly system 1203 may be configured to allow for rapid disassembly of the beam systems 2409 and the cube systems 2410 by pulling apart the components from one another. In some embodiments, the disassembly system 1203 may comprise release button pop up system 2200, hook arm removal system 2100 or support pin removal system 2101.

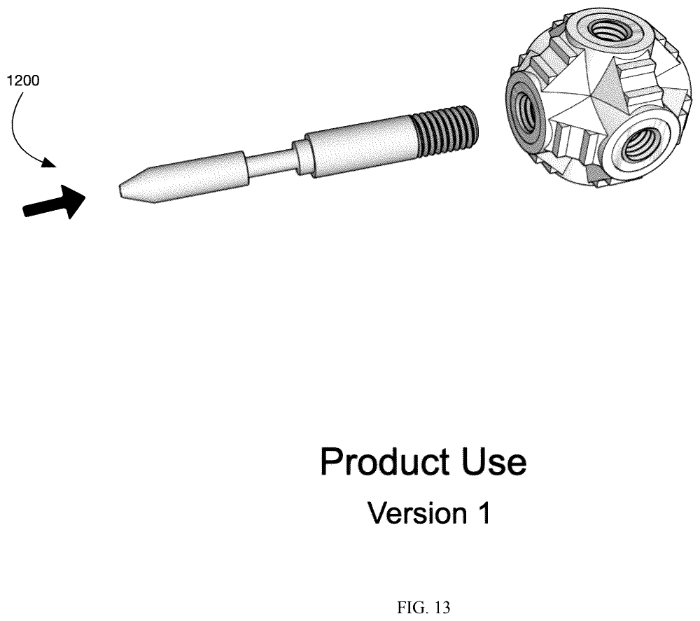

FIG. 13 illustrates a perspective view that shows the directional use of components indicated by dark arrows, while lead line with arrows indicate specific functional processes and the lead lines without arrows indicating the product design features required to complete the functional process, according to an embodiment of the present disclosure.

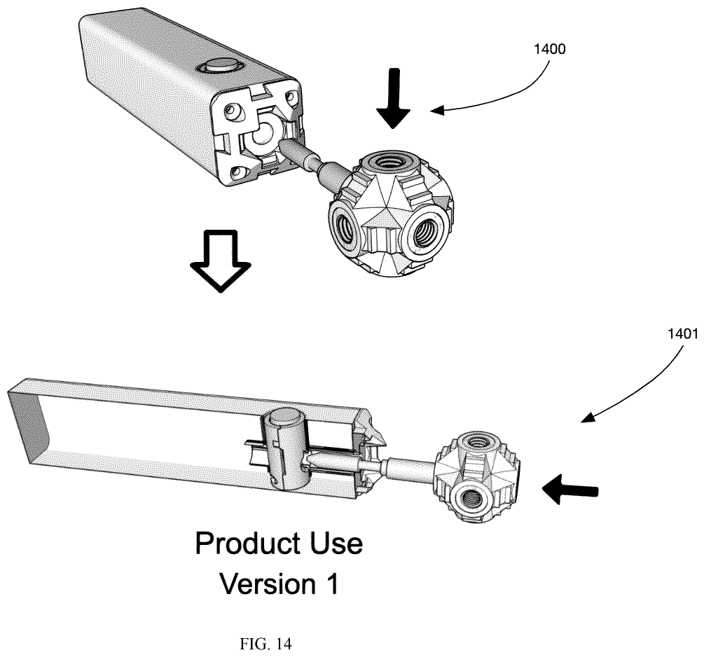

FIG. 14 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure. In some embodiments, the cube orientation system 1400 may be configured to orient the support pin 2402 in front of the support tube 2901 so that it can be inserted into the beam 2400. In some embodiments, the pin insertion system 1401 may be configured to push the support pin 2402 into the support tube 2901 until the support pin locking clip taper 3412 enters the locking sub assembly 2404.

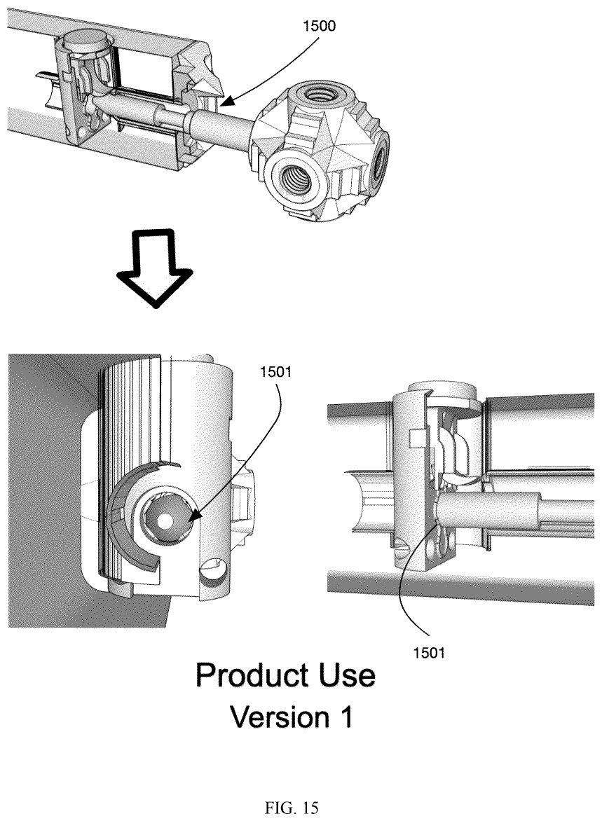

FIG. 15 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure. In some embodiments, the release button reset system 1500 may be configured to ensure that the release button 2407 is unlocked and reset, by having the support pin locking clip front taper 3404 pushing up the release button hook arm 3100 via the release button support pin groove 3109 which releases the hook release button hook 3000 from the release button hook groove 3104. In some embodiments, the locking clip expansion system 1501 may be configured to expand the locking clip 2406 by having the the support pin locking clip back taper 3405 physically widen the locking clip 2406 as the support pin 2402 is pushed through the center of the locking clip 2406.

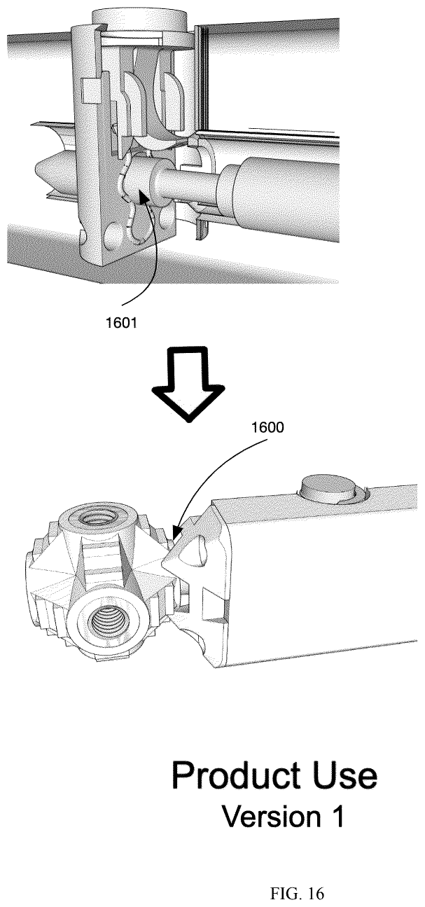

FIG. 16 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure. In some embodiments, the axis orientation guidance system 1600 may be configured to guide the beam 2400 to the right roll, yaw and pitch position by the cube transition wedge 3408 as the support pin 2402 travels further into the beam 2400. In some embodiments, the anchor shaft traversal system 1601 may be configured to guided the support pin 2402 further into the depth of the beam 2400 allowing for the subsequent correct orientation as mediated by the axis orientation guidance system 1600 and allowing for the locking clip 2406 to be used to lock the beam 2400 to the cube 2403 once the proper axes are established.

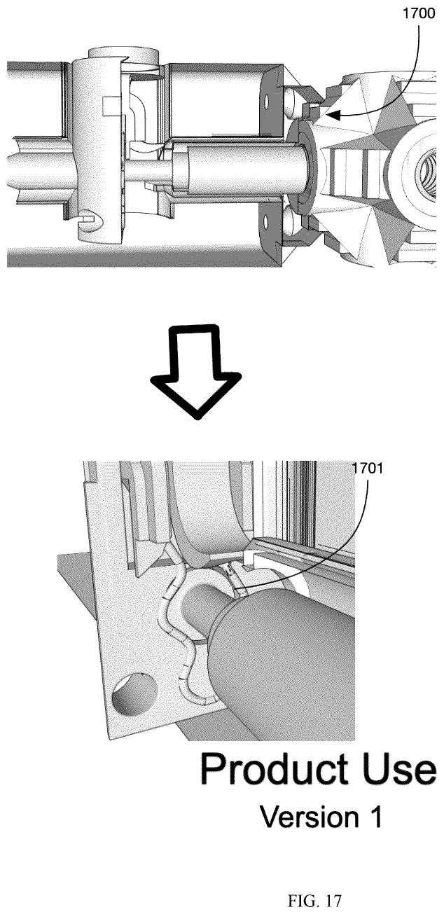

FIG. 17 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure. In some embodiments, the support attachment system 1700 may be configured to allow the cube teeth 3407 and the support teeth receiving region 2906 combine along with the cube circle face 3410 and support circle 2907 to stabilize the beam 2400 in the correct orientation. In some embodiments, the locking support system 1701 may be configured to locking the beam 2400 to the cube 2403 by having the locking clip 2406 collapse onto the support pin release button shaft 3402 so that the support pin locking clip face 3409 now prevents the support pin 2402 from being pulled out of the beam 2400.

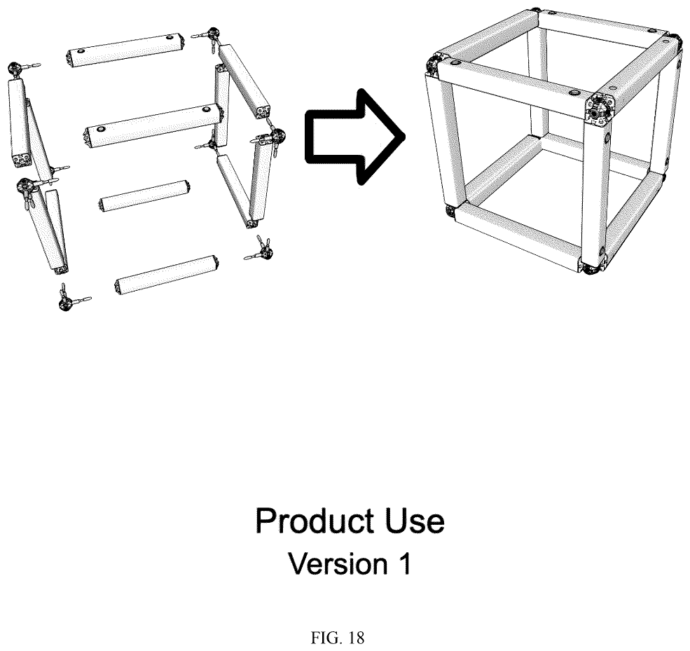

FIG. 18 illustrates a perspective view that shows that after inserting many beams into cubes a simple box representative of a simple furniture design, which is now ready for a user, according to an embodiment of the present disclosure.

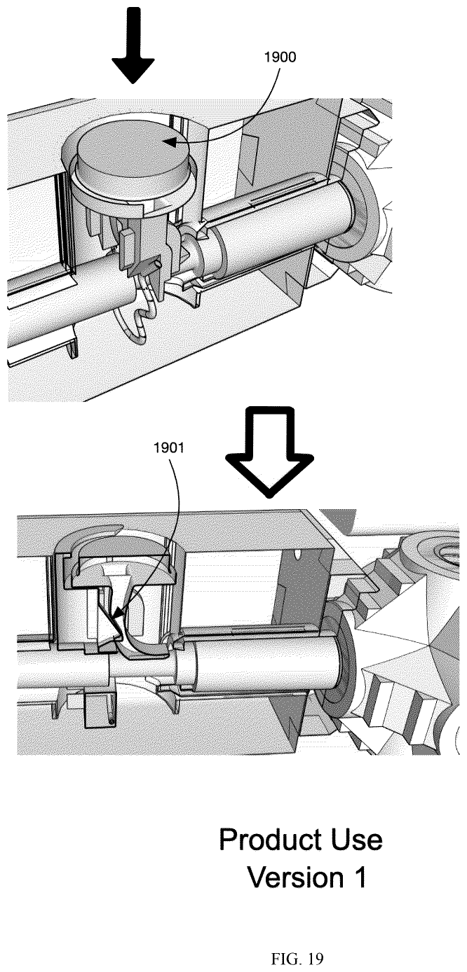

FIG. 19 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure. In some embodiments, the button press system 1900 may be configured to depress the release button 2407 while in a locked state (Beam is attached to cube 2403 expanding the locking clip 2406 so the support pin 2402 can be withdrawn. In some embodiments, the hook arm catch system 1901 may be configured to allow for the hook release button hook 3000 to catch on the release button hook groove 3104 which keeps the release button 2407 depressed and the locking clip 2406 expanded.

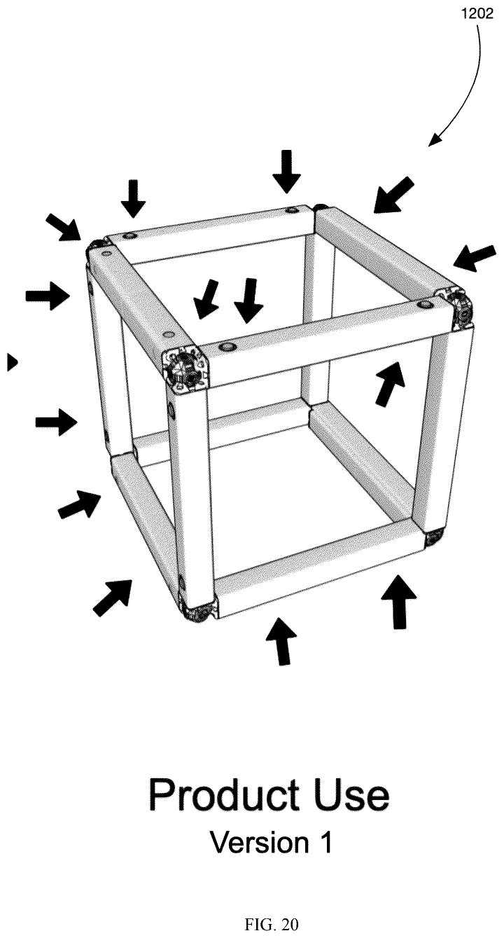

FIG. 20 illustrates a perspective view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

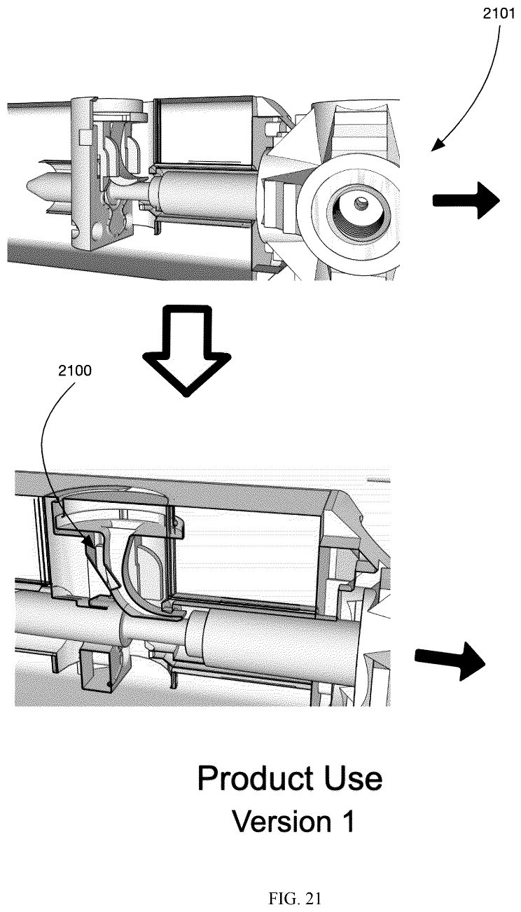

FIG. 21 illustrates a perspective view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure. In some embodiments, the hook arm removal system 2100 may be configured to force the hook release button hook 3000 out of release button hook groove 3104 because the support pin locking clip face 3409 pulled the release button hook arm 3100. In some embodiments, the support pin removal system 2101 may be configured to allow the the cube 2403 to be pulled apart from the beam 2400 while the release button 2407 is locked down allowing the locking clip 2406 back over the support pin anchor shaft 3406 allowing removal of the support pin 2402.

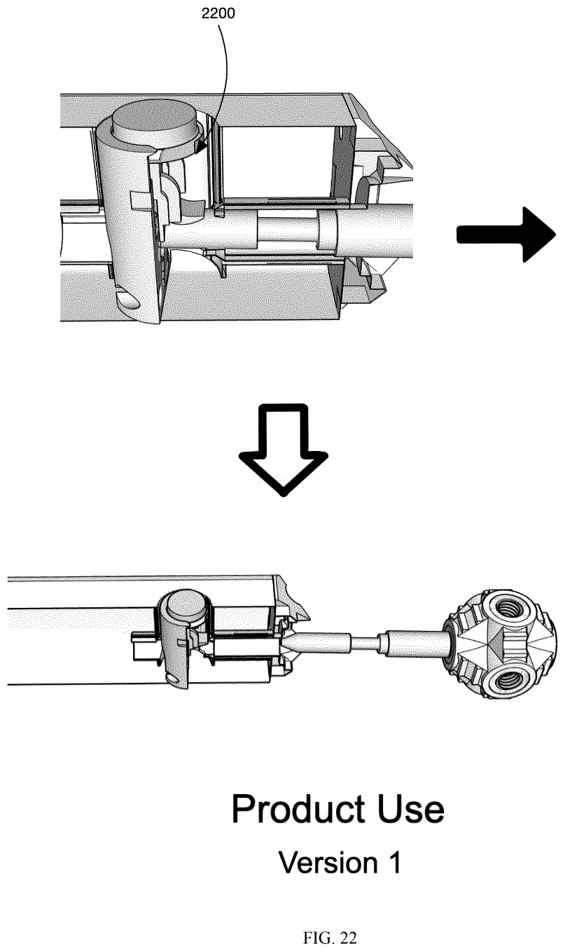

FIG. 22 illustrates a partial perspective cross-section view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure. In some embodiments, the release button pop up system 2200 may be configured to release the release button 2407 from its locked open state and popping up the button because the locking clip 2406 spring has forced it up.

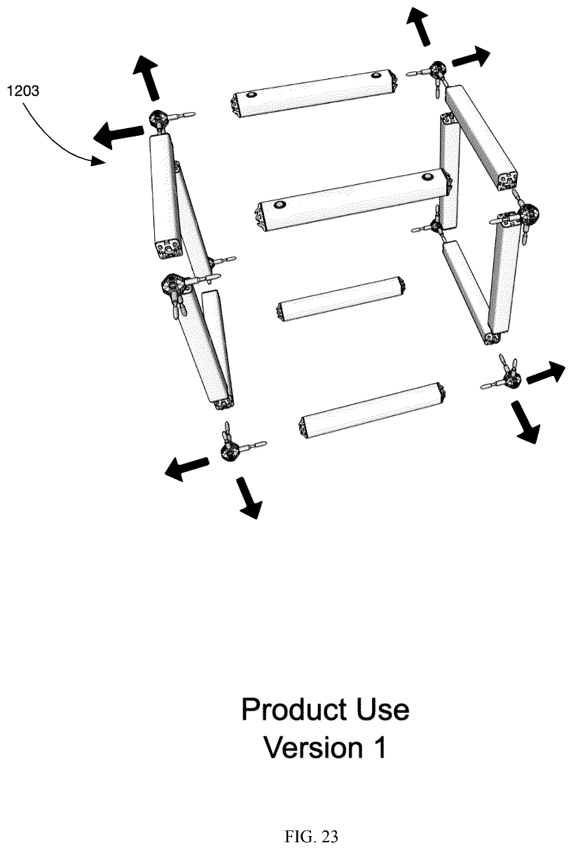

FIG. 23 illustrates an exploded perspective view that shows the directional use of components indicated by dark arrows, while lead line with arrows indicate specific functional processes and the lead lines without arrows indicating the product design features required to complete the functional process, while white arrows indicate the next consecutive process to be performed, according to an embodiment of the present disclosure.

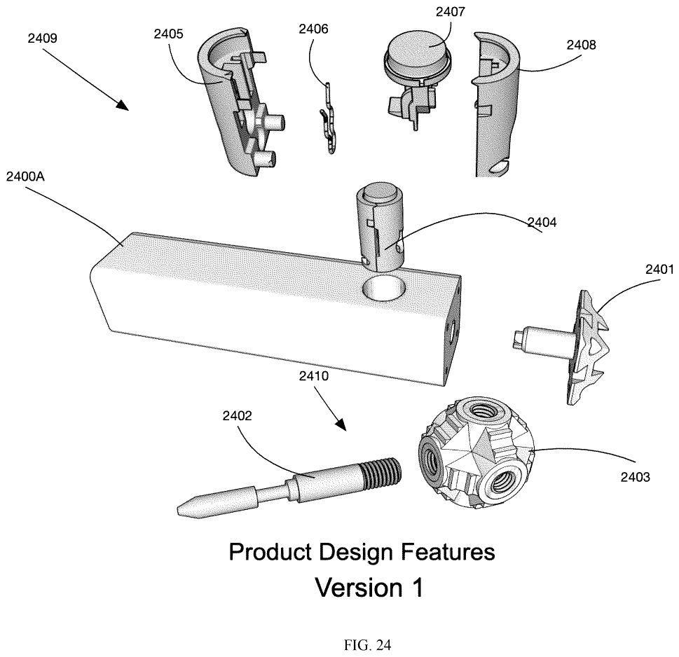

FIG. 24 illustrates a perspective view that shows general components and their design features, according to an embodiment of the present disclosure. In some embodiments, the beam 2400 may be configured to provide structural support for the furniture design, interact with one or more cubes to create furniture according to a design and house an assembly that allows for rapid connection and disconnection in concert with other beam 2400. In some embodiments, the beam 2400 may comprise beam support anchor pilot hole 2801, beam support tube hole 2802, beam locking sub assembly opening 2800 or beam support pin anchor tube opening. In some embodiments, the support 2401 may be configured to interact with the one face of the cube 2403 in order to form a stable support for a furniture design. In some embodiments, the support 2401 may comprise support transition face 2900, support tube 2901, support tube cutout 2902, support holding arm 2903, support pin hole 2904, support teeth receiving region 2906, support circle 2907, support channel cutaway 2908, support beam face 2909 or support anchor hole 2905. In some embodiments, the support pin 2402 may be configured to provide the longitudinal structural support for stable connections between a beam 2400 and a cube 2403. In some embodiments, the support pin 2402 may comprise support pin locking clip taper 3412, support pin anchor shaft 3406, support pin main shaft 3403, support pin screw threads 3400, support pin release button shaft 3402 or support pin locking clip face 3409. In some embodiments, the cube 2403 may have a count of approximately 6 faces for support pin 2402. In some embodiments, the cube 2403 may have a count less than or equal to 12 faces. In some embodiments, the cube 2403 may have a count greater than or equal to 2 faces. In some embodiments, the cube 2403 may have a height of approximately 3 inches. In some embodiments, the cube 2403 may have a height less than or equal to 0.5 inch. In some embodiments, the cube 2403 may have a height greater than or equal to 6 inches. In some embodiments, the cube 2403 is manufactured by the cube manufacturing system 901. In some embodiments, the cube 2403 may interact with a plurality of support pin 2402 according to a furniture design. In some embodiments, the cube 2403 may contain the material ABS plastic or composite materials. In some embodiments, the cube 2403 may comprise cube transition wedge 3408, cube teeth 3407, cube hole 3411, cube circle face 3410 or cube threads 3401. In some embodiments, the locking sub assembly 2404 may be configured to perform the rapid assembly and disassembly functions between the beam 2400 and the cube 2403. In some embodiments, the locking sub assembly 2404 may comprise key 2405, release button 2407, locking clip 2406, hook 2408 or sleeve 2500. In some embodiments, the key 2405 may be configured to act with the other locking sub assembly 2404 components to instantiate rapid assembly and disassembly. In some embodiments, the key 2405 may comprise key support tube cutout 2609, key locking clip foundation slot 2600, key locking clip spacer 2601, key face 2602, key upper anchor 2603, key release button hook arm channel 2604, key release button guide channel 2605, key lower anchor 2610, key top portion 2611 or key back slot 3008. In some embodiments, the locking clip 2406 may be configured to act as spring to maintain the release button 2407 in the popped up state, allow the passage of the support pin 2402 through its middle region when the locking clip 2406 is flexed and act as a gate when contracted to lock the support pin 2402 and stabilize the attachment of the cube 2403 to the beam 2400. In some embodiments, the release button 2407 may be configured to to be depressed by a user when the user wants to disassemble the furniture. In some embodiments, the release button 2407 may interact with the key 2405, hook 2408 and locking clip 2406 to allow for the user to rapidly assemble and disassemble. In some embodiments, the release button 2407 may comprise release button support pin groove 3109, release button hook arm 3100, release button guide arm 3101, release button front guide rail 3102, release button locking clip retainer 3103, release button hook groove 3104, release button locking clip guide face 3106, release button retaining circle 3107, release button cap 3108 or release button rear guide rail 3105. In some embodiments, the hook 2408 may be configured to serve as part of the housing for the locking sub assembly 2404 and interact with the key 2405 to keep the forces of the locking clip 2406 so they do not break the assembly. In some embodiments, the hook 2408 may comprise hook release button hook 3000, hook release button main channel 3003, hook key upper anchor slot 3005, hook release button floor 3006, hook support pin hole 3007, hook top portion 2709 or hook back slot 2708. In some embodiments, the beam systems 2409 may be configured to allow for structural support, allow for rapid assembling and allow for rapid disassembly. In some embodiments, the beam systems 2409 may comprise locking sub assembly 2404, support 2401 or beam 2400. Cube systems 2410 may be defined as a set of cube 2403 and set of support pin 2402 that acts in concert with a beam systems 2409 to complete a furniture design. In some embodiments, the cube systems 2410 may be configured to act in concert with beam systems 2409 to create a piece of furniture when assembled. In some embodiments, the cube systems 2410 may comprise cube 2403 or support pin 2402.

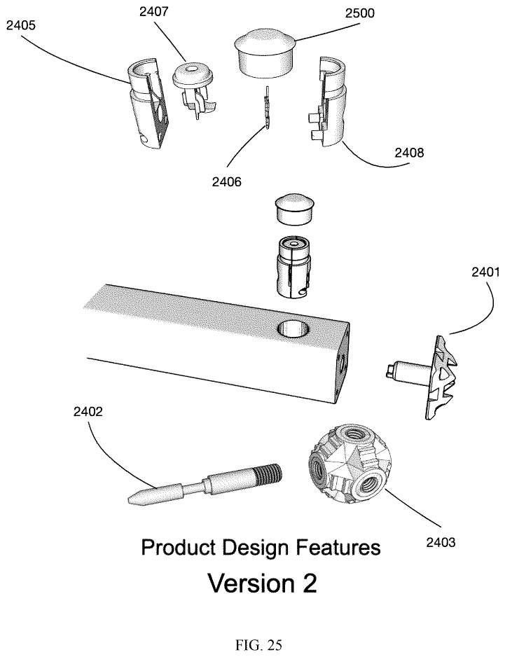

FIG. 25 illustrates a perspective view that shows general components and their design features, according to an embodiment of the present disclosure. In some embodiments, the sleeve 2500 may be configured to slide over the hook top portion 2709 and key top portion 2611, cover the release button 2407, squeeze in on the key sleeve inner ring 2704 and the key sleeve outer ring 2700, slide over the key sleeve outer ring 2700 and the hook sleeve outer ring 2701 and insert into the release button insert recess 3201.

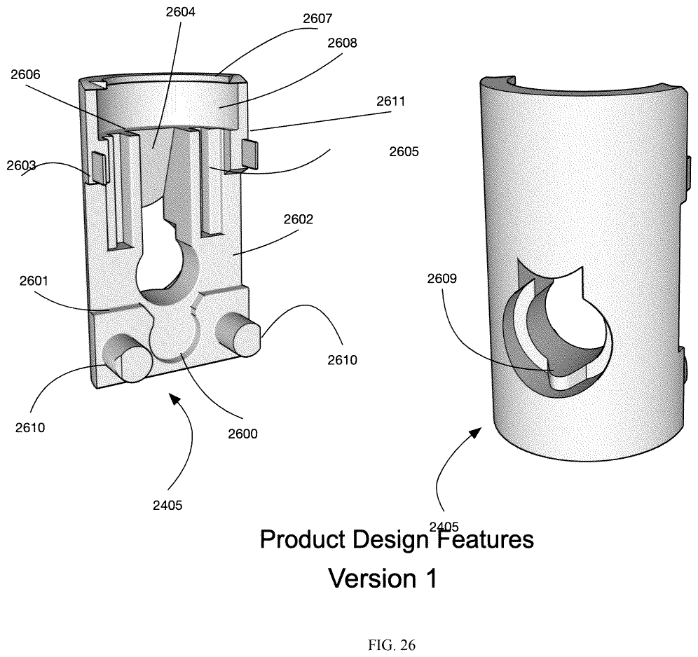

FIG. 26 illustrates a perspective view that shows the key and its design features, according to an embodiment of the present disclosure. In some embodiments, the key locking clip foundation slot 2600 may be configured to receive and orient the locking clip 2406 in a vertical position. In some embodiments, the key locking clip spacer 2601 may be configured to provide space for the width of the locking clip 2406. In some embodiments, the key face 2602 may be configured to act as a backstop for the locking clip 2406 when an assembled locking sub assembly 2404 is being used. In some embodiments, the key upper anchor 2603 may be configured to close the locking sub assembly 2404 along with the hook key upper anchor slot 3005. In some embodiments, the key release button hook arm channel 2604 may be configured to provide space for the release button hook arm 3100 and its vertical actuation. In some embodiments, the key release button guide channel 2605 may be configured to allow actuation of the release button 2407 vertically. In some embodiments, the key release button retaining floor 2606 may be configured to keep the release button 2407 from actuating too far downwards. In some embodiments, the key release button retaining rim 2607 may be configured to keep the release button 2407 from actuating too far upwards. In some embodiments, the key release button retaining channel 2608 may be configured to provide vertical actuation space for the release button 2407. In some embodiments, the key support tube cutout 2609 may be configured to interact with the support tube 2901 to provide proper orientation of the support during assembly. In some embodiments, the key lower anchor 2610 may be configured to close the locking sub assembly 2404 along with the hook lower anchor hole 3004. In some embodiments, the key top portion 2611 may be configured to house attachment and rim-related features. In some embodiments, the key top portion 2611 may comprise key release button retaining channel 2608, key release button retaining floor 2606 or key release button retaining rim 2607.

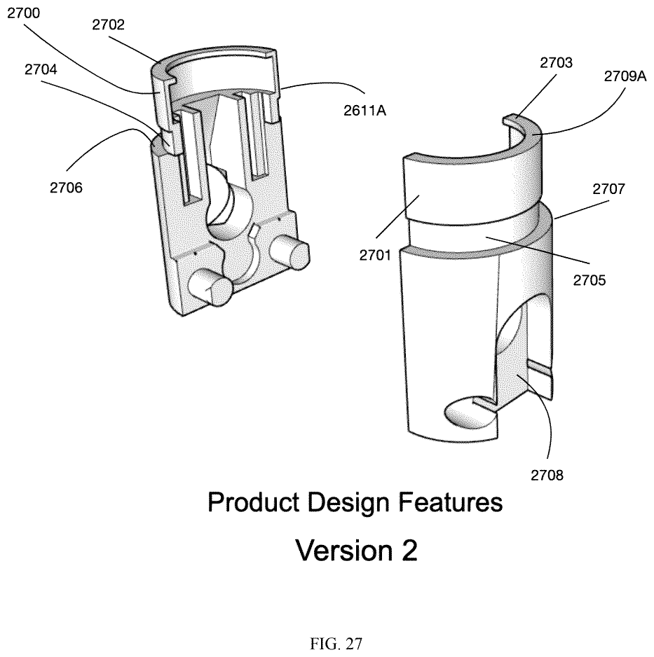

FIG. 27 illustrates a perspective view that shows the key and hook and its design features, according to an embodiment of the present disclosure. In some embodiments, the key sleeve outer ring 2700 may be configured to receive the sleeve 2500 and mirror the key sleeve outer ring 2700. In some embodiments, the hook sleeve outer ring 2701 may be configured to receive the sleeve 2500 and mirror the key sleeve outer ring 2700. In some embodiments, the key sleeve retaining rim 2702 may be configured to support the edges of the sleeve 2500 when covering the release button 2407. In some embodiments, the hook sleeve retaining rim 2703 may be configured to support the edges of the sleeve 2500 when covering the release button 2407. In some embodiments, the key sleeve inner ring 2704 may be configured to provide a region wherein the sleeve 2500 may constrict sealing the sleeve 2500 onto the top portion of the locking sub assembly 2404. In some embodiments, the hook sleeve inner ring 2705 may be configured to support the edges of the sleeve 2500 when covering the release button 2407. In some embodiments, the key sleeve receiving rim 2706 may be configured to provide a region wherein the lip of the sleeve 2500 may rest when placed on the locking sub assembly 2404. In some embodiments, the hook sleeve receiving rim 2707 may be configured to provide a region wherein the lip of the sleeve 2500 may rest when placed on the locking sub assembly 2404. In some embodiments, the key top portion 2611A may be configured to house attachment and rim-related features. In some embodiments, the key top portion 2611A may comprise key sleeve receiving rim 2706, key sleeve inner ring 2704, key sleeve outer ring 2700 or key sleeve retaining rim 2702. In some embodiments, the hook back slot 2708 may be configured to receive an alignment piece from the back. In some embodiments, the hook top portion 2709A may be configured to house attachment and rim-related features. In some embodiments, the hook top portion 2709A may comprise hook sleeve receiving rim 2707, hook sleeve inner ring 2705, hook sleeve outer ring 2701, hook sleeve retaining rim 2703 or hook lower anchor hole 3004.

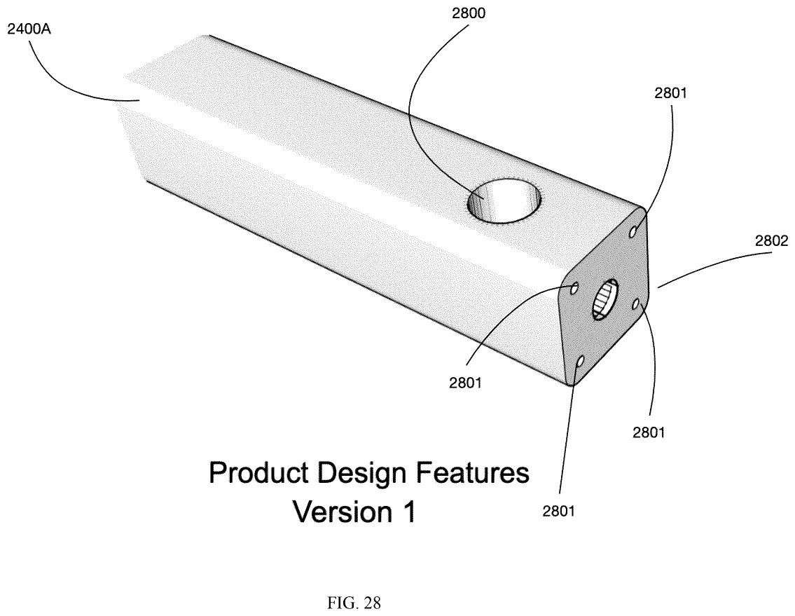

FIG. 28 illustrates a perspective view that shows the beam and its design features, according to an embodiment of the present disclosure. In some embodiments, the beam locking sub assembly opening 2800 may be configured to receive a recessed locking sub assembly 2404. In some embodiments, the beam support anchor pilot hole 2801 may be configured to create a pilot recess for screws to attach the support to the beam 2400. In some embodiments, the beam support anchor pilot hole 2801 may have a count of approximately 4 holes per support 2401. In some embodiments, the beam support tube hole 2802 may be configured to receive the support tube 2901.

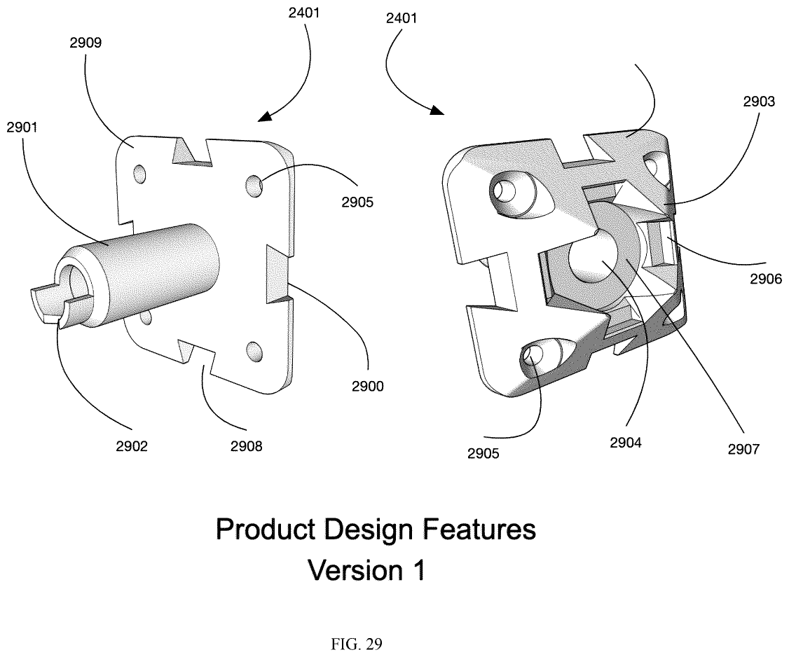

FIG. 29 illustrates a perspective view that shows the support and its design features, according to an embodiment of the present disclosure. In some embodiments, the support transition face 2900 may be configured to create a transition for interaction with the cube teeth 3407. In some embodiments, the support tube 2901 may be configured to guide the support pin 2402 to the locking sub assembly 2404. In some embodiments, the support tube cutout 2902 may be configured to interact with the key support tube cutout 2609 in order to properly orient the support when it is attached to the beam 2400. In some embodiments, the support holding arm 2903 may be configured to interact with the axis orientation guidance system 1600 in order to put the beam 2400 in the proper axis during assembly. In some embodiments, the support pin hole 2904 may be configured to provide a space for screws to sink into the beam support anchor pilot hole 2801. In some embodiments, the support anchor hole 2905 may be configured to serve as a recess guide for screw attachment of the support to the beam 2400. In some embodiments, the support teeth receiving region 2906 may be configured to interact with the cube teeth 3407 to provide stable support. In some embodiments, the support circle 2907 may be configured to interact with the cube circle face 3410 to provide stable support. In some embodiments, the support channel cutaway 2908 may be configured to aid the cube teeth 3407 to structurally bind to the support. In some embodiments, the support beam face 2909 may be configured to rest on the apical end of the beam 2400 to form an attachment surface for a cube 2403.

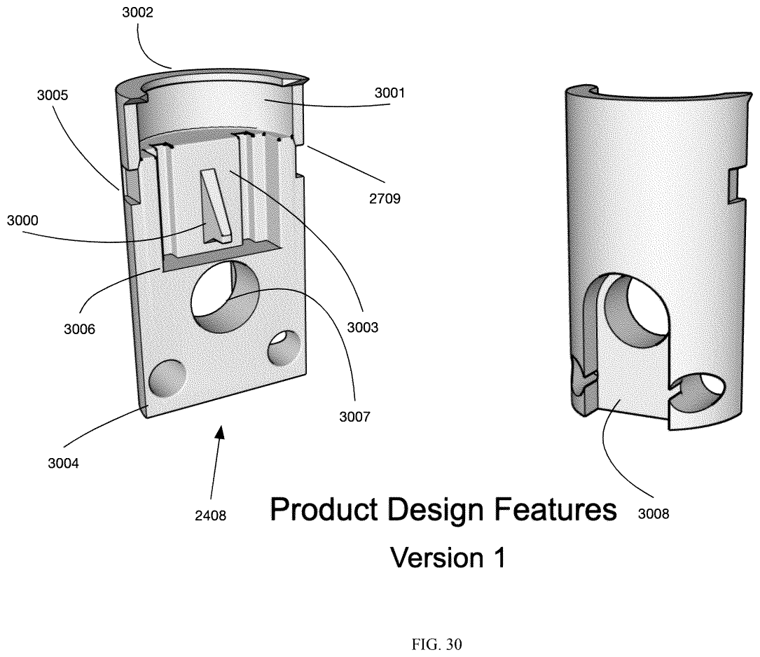

FIG. 30 illustrates a perspective view that shows the hook and its design features, according to an embodiment of the present disclosure. In some embodiments, the hook release button hook 3000 may be configured to catch on the release button hook groove 3104 in order to keep the #release button in a locked down and open position. In some embodiments, the hook release button retaining channel 3001 may be configured to keep the release button 2407 within the locking sub assembly 2404 and oriented to actuate up and down. In some embodiments, the hook release button retaining rim 3002 may be configured to keep the release button 2407 within the locking sub assembly 2404 and prevent from popping out via interaction with the release button retaining circle 3107. In some embodiments, the hook release button main channel 3003 may be configured to guide the release button hook arm 3100 close to the hook release button hook 3000. In some embodiments, the hook lower anchor hole 3004 may be configured to help lock the assembly closed with the key lower anchor 2610. In some embodiments, the hook key upper anchor slot 3005 may be configured to lock the assembly closed with the key upper anchor 2603. In some embodiments, the hook release button floor 3006 may be configured to prevent the release button 2407 from going to far downwards when in use. In some embodiments, the hook support pin hole 3007 may be configured to allow the support pin 2402 to pass through. In some embodiments, the key back slot 3008 may be configured to receive an alignment piece from the back. In some embodiments, the hook top portion 2709 may be configured to house attachment and rim-related features. In some embodiments, the hook top portion 2709 may comprise hook release button retaining channel 3001 or hook release button retaining rim 3002.

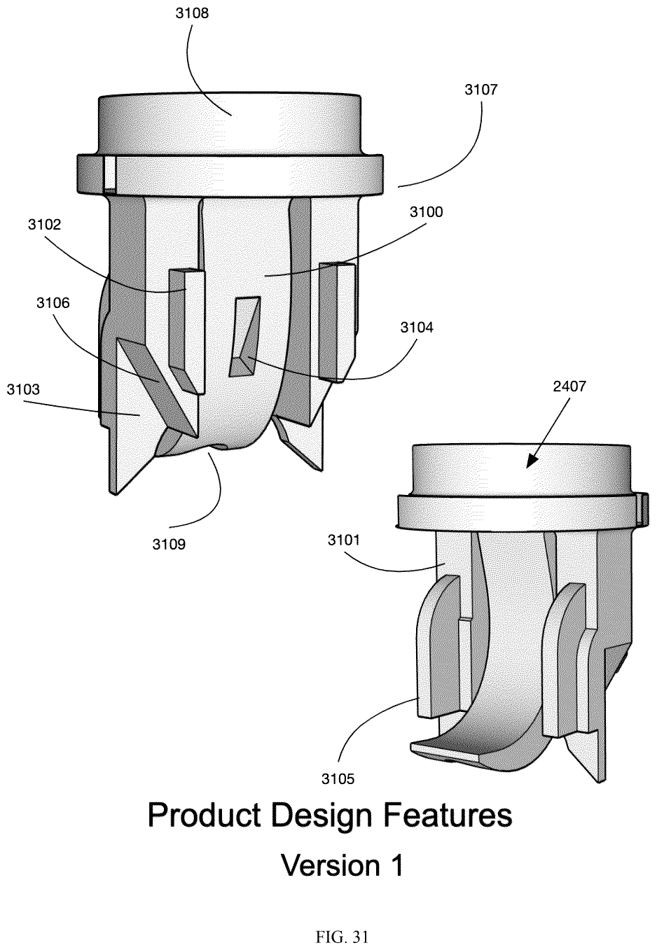

FIG. 31 illustrates a perspective view that shows the release button and its design features, according to an embodiment of the present disclosure. In some embodiments, the release button hook arm 3100 may be configured to mediate the locking down of the release button 2407. In some embodiments, the release button hook arm 3100 may interact in multiple ways: it may interact with the support pin 2402 in order to reset the release button 2407 according to the release button reset system 1500 and it also may interact with the support pin locking clip face 3409 in order to pull the hook release button hook 3000 out of the release button hook groove 3104. In some embodiments, the release button hook arm 3100 may be positioned within the support pin release button shaft 3402 region when the button is locked down, above the support pin anchor shaft 3406 during insertion as in the anchor shaft traversal system 1601 or above the support pin anchor shaft 3406 during removal as in the support pin removal system 2101. In some embodiments, the release button hook arm 3100 may contain the material ABS plastic. In some embodiments, the release button hook arm 3100 may be shaped like a J or a hook. In some embodiments, the release button hook arm 3100 may be positioned central to release button front guide rail 3102. In some embodiments, the release button hook arm 3100 can flex like a spring. In some embodiments, the release button guide arm 3101 may be configured to fit within the key release button guide channel 2605 during assembly and actuate up and down during use using the key release button guide channel 2605 as a rail. In some embodiments, the release button front guide rail 3102 may be configured to help actuate up and down motion of the button. In some embodiments, the release button locking clip retainer 3103 may be configured to keep the locking clip 2406 in the proper position while in use. In some embodiments, the release button hook groove 3104 may be configured to interact with the hook release button hook 3000 to lock the release button 2407 in the down position. In some embodiments, the release button hook groove 3104 may be positioned on the release button hook arm 3100 or opposing the hook release button hook 3000. In some embodiments, the release button hook groove 3104 shape and depth substantially match that of the hook release button hook 3000. In some embodiments, the release button hook groove 3104 may interact with the hook release button hook 3000 during implementation of the locking system. In some embodiments, the release button rear guide rail 3105 may be configured to aid the release button 2407 in providing stable vertical actuation when in use. In some embodiments, the release button locking clip guide face 3106 may be configured to create an angle for the expansion and contraction of the locking clip 2406 as related to the vertical orientation of the release button 2407. In some embodiments, the release button retaining circle 3107 may be configured to interact with the key release button retaining rim 2607 to keep the release button 2407 within the locking sub assembly 2404 during use. In some embodiments, the release button cap 3108 may be configured to act as a surface to be pressed by the user. In some embodiments, the release button support pin groove 3109 may be configured to interact with the support pin 2402 in order to help reset a depressed button as in the release button reset system 1500.

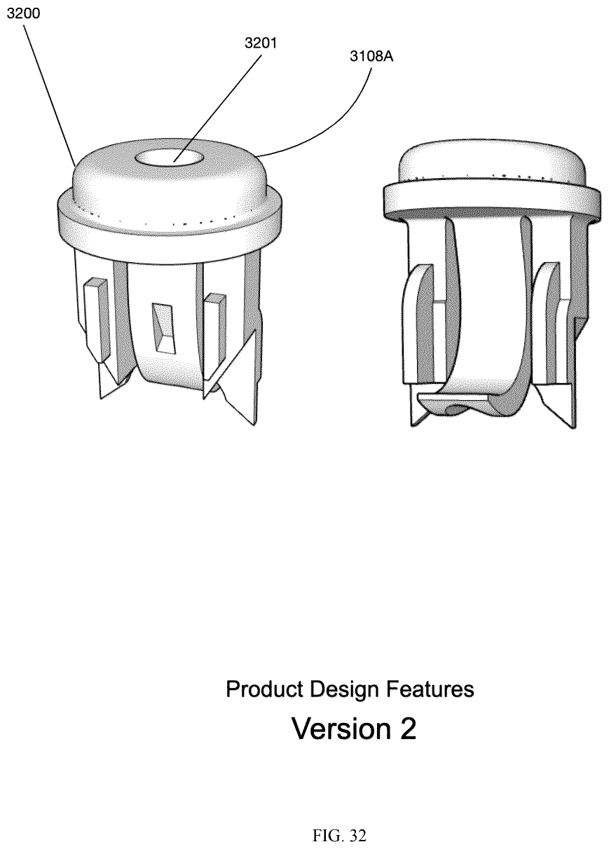

FIG. 32 illustrates a perspective view that shows the release button and its design features, according to an embodiment of the present disclosure. In some embodiments, the release button rounded edge 3200 may be configured to allow the sleeve 2500 to slide on easily. In some embodiments, the release button insert recess 3201 may be configured to receive the sleeve 2500 insert button. In some embodiments, the release button cap 3108A may be configured to act as a surface to be pressed by the user. In some embodiments, the release button cap 3108A may comprise release button rounded edge 3200 or release button insert recess 3201.

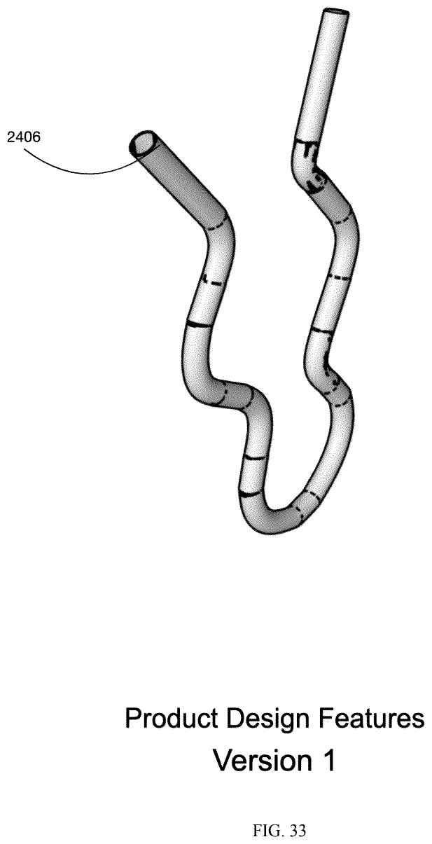

FIG. 33 illustrates a perspective view that shows the locking clip and its design features, according to an embodiment of the present disclosure.

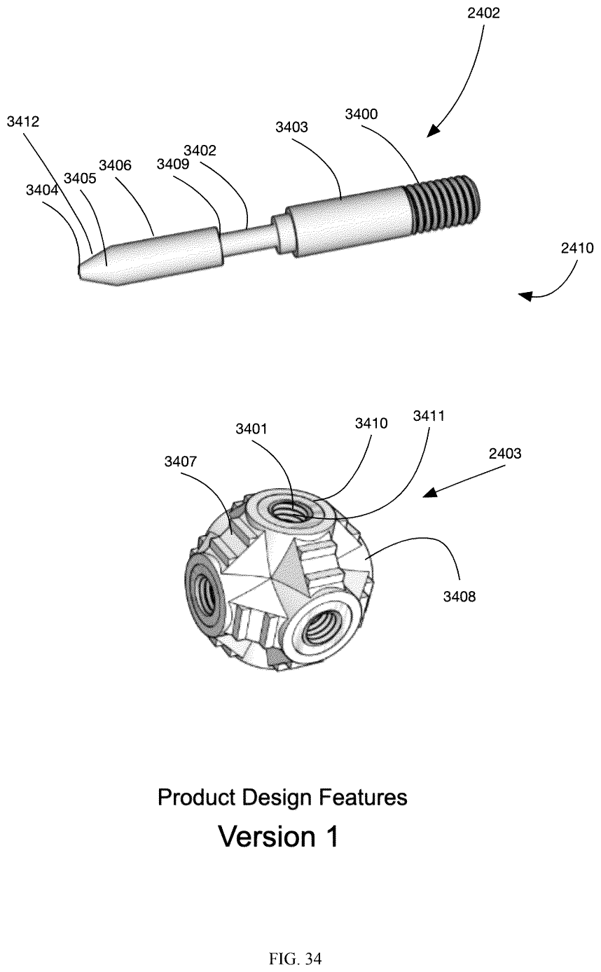

FIG. 34 illustrates a perspective view that shows a cube system and its design features, according to an embodiment of the present disclosure. In some embodiments, the support pin screw threads 3400 may be configured to interact with the cube threads 3401 to make a secure attachment to the cube 2403. In some embodiments, the cube threads 3401 may be configured to attach to a support pin 2402 via support pin screw threads 3400. In some embodiments, the support pin release button shaft 3402 may be configured to receive the release button hook arm 3100 into its region when the release button 2407 is in its locked open state. In some embodiments, the support pin main shaft 3403 may be configured to provide the main structural support for the support pin 2402. In some embodiments, the support pin locking clip front taper 3404 may be configured to serve as a means to create tolerance for the accuracy of insertion of the support pin 2402 into support tube 2901. In some embodiments, the support pin locking clip back taper 3405 may be configured to expand the locking clip 2406 when the support pin 2402 is pushed in, when assembling the furniture. In some embodiments, the support pin anchor shaft 3406 may be configured to serve as a traversal path for the locking clip 2406 to allow for attachment of the cube teeth 3407 to the support teeth receiving region 2906 stabilizing the attachment. In some embodiments, the cube teeth 3407 may be configured to secure, in concert with an opposing cube teeth 3407 on the opposite side of a cube circle face 3410, a beam 2400 in an axis plane. In some embodiments, the cube transition wedge 3408 may be configured to guide the four support holding arm 2903 into a proper axis for beam 2400 attachment. In some embodiments, the support pin locking clip face 3409 may be configured to provide the barrier to prevent the locking clip 2406 from sliding, essentially locking the beam 2400 to the cube 2403. In some embodiments, the support pin locking clip face 3409 serves to lock the beam 2400 to the support pin 2402 when the locking clip 2406 collapses onto the support pin release button shaft 3402. In some embodiments, the cube circle face 3410 may be configured to interact with the support circle 2907 to form a tight seal when assembled and locked to provide stability to a joint. In some embodiments, the cube hole 3411 may be configured to receive a support pin 2402. In some embodiments, the support pin locking clip taper 3412 may be configured to serve as a guide to help orient the support pin 2402 and also expand the locking clip 2406 when a support pin 2402 is inserted. In some embodiments, the support pin locking clip taper 3412 may comprise support pin locking clip front taper 3404 or support pin locking clip back taper 3405.

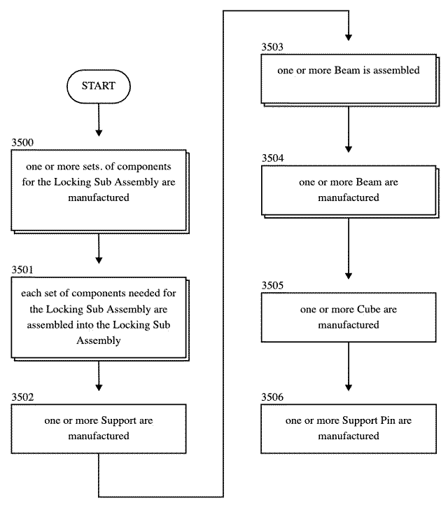

FIG. 35 is a method diagram which describes the manufacture according to an embodiment of the present disclosure. First, one or more sets. of components for the locking sub assembly 2404 are manufactured via the locking sub assembly manufacturing system 100 (Step 3500). Then each set of components needed for the locking sub assembly 2404 are assembled into the locking sub assembly 2404 via the locking sub assembly assembly system 300 (Step 3501). Then one or more support 2401 are manufactured via the support manufacturing system 500 (Step 3502). Then one or more beam 2400 is assembled via the beam assembly system 702 (Step 3503). Then one or more beam 2400 are manufactured via the beam system manufacturing process 600 (Step 3504).

Then one or more cube 2403 are manufactured via the cube manufacturing system 901 (Step 3505). Then one or more support pin 2402 are manufactured via the support pin manufacturing system 900 (Step 3506).

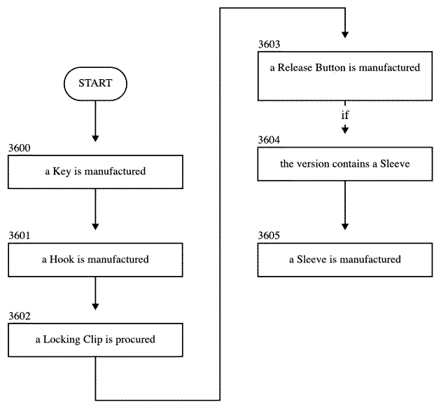

FIG. 36 is a method diagram which describes the locking sub assembly manufacturing system 100 according to an embodiment of the present disclosure. First, a key 2405 is manufactured via the key manufacturing system 101 (Step 3600). Then a hook 2408 is manufactured via the hook manufacturing system 102 (Step 3601). Then a locking clip 2406 is procured via the locking clip manufacturing system 103 (Step 3602). Then a release button 2407 is manufactured via the release button manufacturing system 104 (Step 3603). If the version contains a sleeve 2500 (Step 3604), a sleeve 2500 is manufactured via the sleeve manufacturing system 200 (Step 3605).

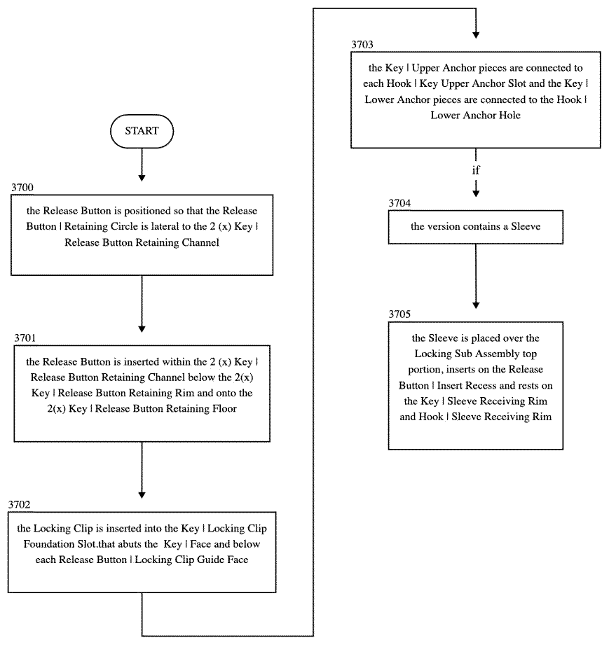

FIG. 37 is a method diagram which describes the locking sub assembly assembly system 300 according to an embodiment of the present disclosure.

First, the release button 2407 is positioned so that the release button retaining circle 3107 is lateral to the key release button retaining channel 2608 via the release button assembly positioning system 301 (Step 3700). Then the release button 2407 is inserted within the key release button retaining channel 2608 below the key release button retaining rim 2607 and onto the key release button retaining floor 2606 via the release button assembly insertion system 302 (Step 3701). Then the locking clip 2406 is inserted into the key locking clip foundation slot 2600.that abuts the key face 2602 and below each release button locking clip guide face 3106 via the locking clip insertion system 303 (Step 3702). Then the key upper anchor 2603 pieces are connected to each hook key upper anchor slot 3005 and the key lower anchor 2610 pieces are connected to the hook lower anchor hole 3004 via the locking sub assembly capping system 304 (Step 3703). If the version contains a sleeve 2500 (Step 3704), the sleeve 2500 is placed over the locking sub assembly 2404 top portion, inserts on the release button insert recess 3201 and rests on the key sleeve receiving rim 2706 and hook sleeve receiving rim 2707 via the sleeve capping system 400 (Step 3705).

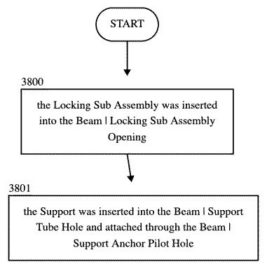

FIG. 38 is a method diagram which describes the beam assembly system 702 according to an embodiment of the present disclosure. First, the locking sub assembly 2404 was inserted into the beam locking sub assembly opening 2800 via the insert lock system 700 (Step 3800). Then the support 2401 was inserted into the beam support tube hole 2802 and attached through the beam support anchor pilot hole 2801 via the attach support system 701 (Step 3801).

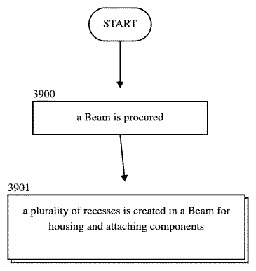

FIG. 39 is a method diagram which describes the beam system manufacturing process 600 according to an embodiment of the present disclosure. First, a beam 2400 is procured via the beam substrate manufacturing system 601 (Step 3900). Then a plurality of recesses is created in a beam 2400 for housing and attaching components via the beam recess creation system 602 (Step 3901).

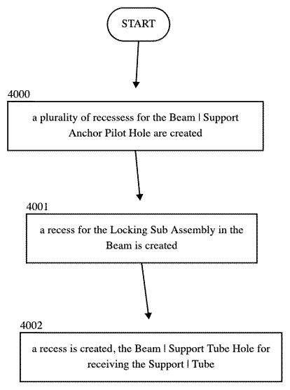

FIG. 40 is a method diagram which describes the beam recess creation system 602 according to an embodiment of the present disclosure. First, a plurality of recesses for the beam support anchor pilot hole 2801 are created via the pilot hole creation system 604 (Step 4000). Then a recess for the locking sub assembly 2404 in the beam 2400 is created via the locking sub assembly recess creation system 603 (Step 4001). Then a recess is created, the beam support tube hole 2802 for receiving the support tube 2901 via the support tube hole creation system 605 (Step 4002).

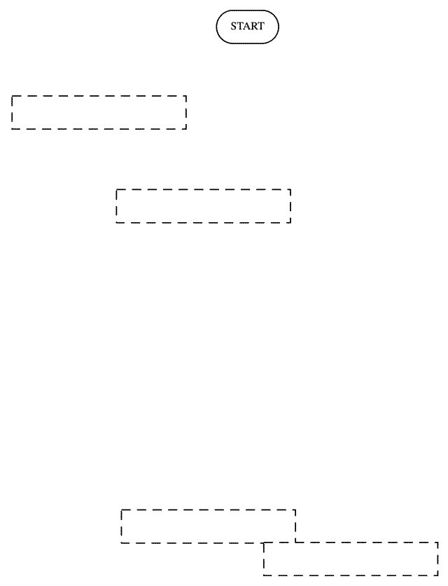

FIG. 41 is a method diagram which describes the beam 2400 according to an embodiment of the present disclosure.

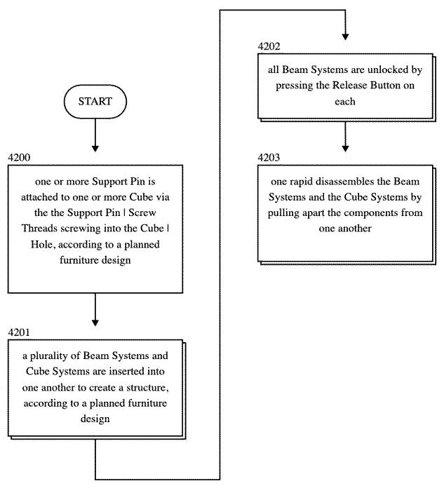

FIG. 42 is a method diagram which describes the use according to an embodiment of the present disclosure. First, one or more support pin 2402 is attached to one or more cube 2403 via the support pin screw threads 3400 screwing into the cube hole 3411, according to a planned furniture design via the prepare joint system 1200 (Step 4200). Then a plurality of beam systems 2409 and cube systems 2410 are inserted into one another to create a structure, according to a planned furniture design via the furniture locking assembly system 1201 (Step 4201). Then all beam systems 2409 are unlocked by pressing the release button 2407 on each via the unlock all furniture system 1202 (Step 4202). Then one rapidly disassembles the beam systems 2409 and the cube systems 2410 by pulling apart the components from one another via the disassembly system 1203 (Step 4203).

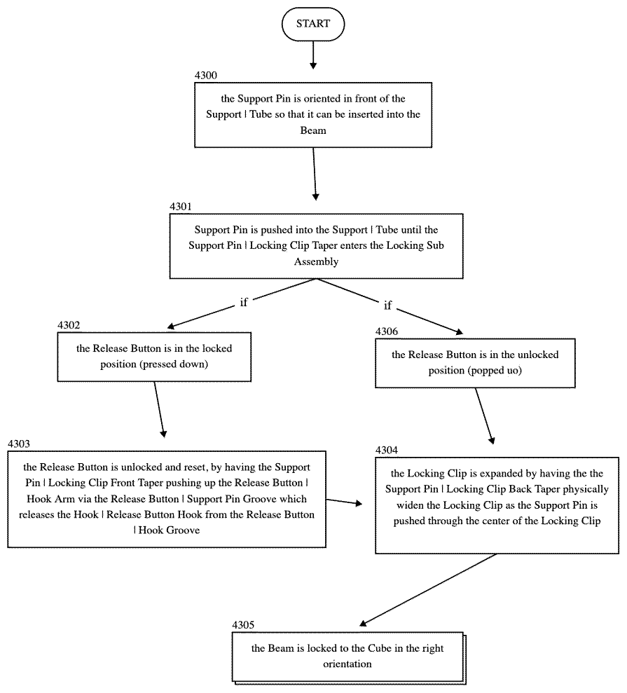

FIG. 43 is a method diagram which describes the furniture locking assembly system 1201 according to an embodiment of the present disclosure. First, the support pin 2402 is oriented in front of the support tube 2901 so that it can be inserted into the beam 2400 via the cube orientation system 1400 (Step 4300). Then support pin 2402 is pushed into the support tube 2901 until the support pin locking clip taper 3412 enters the locking sub assembly 2404 via the pin insertion system 1401 (Step 4301). If the release button 2407 is in the locked position (pressed down) (Step 4302), the release button 2407 is unlocked and reset, by having the support pin locking clip front taper 3404 pushing up the release button hook arm 3100 via the release button support pin groove 3109 which releases the hook release button hook 3000 from the release button hook groove 3104 via the release button reset system 1500 (Step 4303). Then the locking clip 2406 is expanded by having the the support pin locking clip back taper 3405 physically widen the locking clip 2406 as the support pin 2402 is pushed through the center of the locking clip 2406 via the locking clip expansion system 1501 (Step 4304). Then the beam 2400 is locked to the cube 2403 in the right orientation via the locking system (Step 4305). If the release button 2407 is in the unlocked position (popped up) (Step 4306), then refer back to Step 4304.

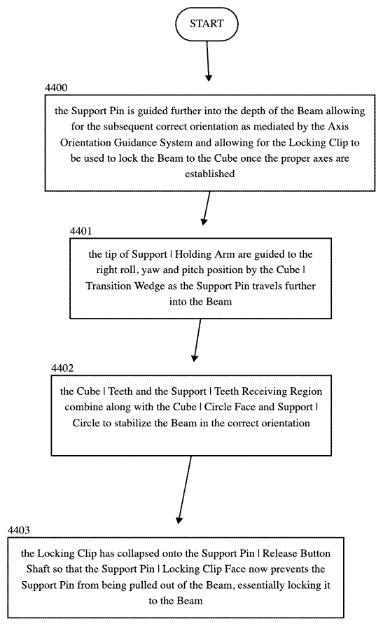

FIG. 44 is a method diagram which describes the locking system according to an embodiment of the present disclosure. First, the support pin 2402 is guided further into the depth of the beam 2400 allowing for the subsequent correct orientation as mediated by the axis orientation guidance system 1600 and allowing for the locking clip 2406 to be used to lock the beam 2400 to the cube 2403 once the proper axes are established via the anchor shaft traversal system 1601 (Step 4400). Then the tip of support holding arm 2903 are guided to the right roll, yaw and pitch position by the cube transition wedge 3408 as the support pin 2402 travels further into the beam 2400 via the axis orientation guidance system 1600 (Step 4401). Then the cube teeth 3407 and the support teeth receiving region 2906 combine along with the cube circle face 3410 and support circle 2907 to stabilize the beam 2400 in the correct orientation via the support attachment system 1700 (Step 4402). Then the locking clip 2406 has collapsed onto the support pin release button shaft 3402 so that the support pin locking clip face 3409 now prevents the support pin 2402 from being pulled out of the beam 2400, essentially locking it to the beam 2400 via the locking support system 1701 (Step 4403).

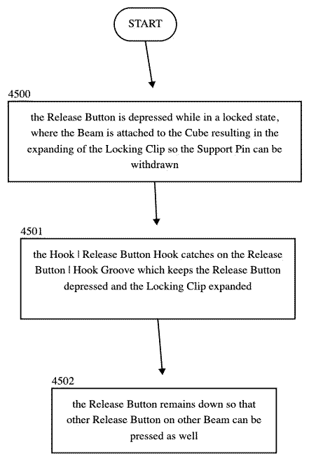

FIG. 45 is a method diagram which describes the unlock all furniture system 1202 according to an embodiment of the present disclosure. First, the release button 2407 is depressed while in a locked state, where the Beam is attached to the cube 2403 resulting in the expanding of the locking clip 2406 so the support pin 2402 can be withdrawn via the button press system 1900 (Step 4500). Then the hook release button hook 3000 catches on the release button hook groove 3104 which keeps the release button 2407 depressed and the locking clip 2406 expanded via the hook arm catch system 1901 (Step 4501). Then the release button 2407 remains down so that other release button 2407 on other beam 2400 can be pressed as well (Step 4502).

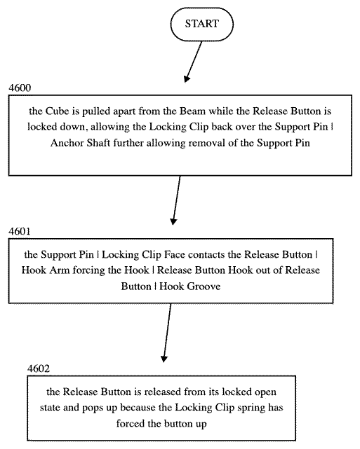

FIG. 46 is a method diagram which describes the disassembly system 1203 according to an embodiment of the present disclosure. First, the cube 2403 is pulled apart from the beam 2400 while the release button 2407 is locked down, allowing the locking clip 2406 back over the support pin anchor shaft 3406 further allowing removal of the support pin 2402 via the support pin removal system 2101 (Step 4600). Then the support pin locking clip face 3409 contacts the release button hook arm 3100 forcing the hook release button hook 3000 out of release button hook groove 3104 via the hook arm removal system 2100 (Step 4601). Then the release button 2407 is released from its locked open state and pops up because the locking clip 2406 spring has forced the button up via the release button pop up system 2200 (Step 4602).

1. I claim a furniture locking assembly system:
the furniture locking assembly system configured to assemble a plurality of beam systems and cube systems according to a furniture design;
comprising a beam system;
configured to allow for structural support;
comprising a plurality of beams;
comprising a cube system;
configured to act in concert with the beam systems to create a piece of furniture when assembled;
comprising a plurality of cubes;
said cubes configured to connect via one or more of the beams;
the beam system comprising one or more locking systems;
configured to lock a beam to a cube in the right orientation;
a locking system comprising a locking sub assembly;
configured to perform the rapid assembly and disassembly functions between the beam and the cube;
the furniture locking assembly system comprising an unlock all furniture system;
the unlock all furniture system configured to allow rapid disassembly of an assembled furniture design, by unlocking all beam systems prior to pulling them apart and disassembling, essentially unlocking everything at once;
said unlock all furniture system configured to comprise a button press system; the button press system configured to depress the release button while in a locked state expanding the locking clip so the support pin can be withdrawn;
the button press system comprising a release button to be depressed by a user when the user wants to disassemble the furniture;
the furniture locking assembly system comprising a disassembly system;
the disassembly system is configured to allow for rapid disassembly of the beam systems and the cube systems by pulling apart the components from one another.

2. The system of claim 1 wherein said button press system comprises a release button hook arm wherein the release button hook arm configured to mediate the locking down of the release button.

3. The system of claim 2 wherein said locking assembly comprises a key wherein the key if configured to act with the other locking sub assembly components to instantiate rapid assembly and disassembly;
said locking assembly comprising a hook;
said hook configured to act with the other locking sub assembly components to instantiate rapid assembly and disassembly.

4. The system of claim 3 wherein said release button hook arm can flex like a spring.

5. The system of claim 4 wherein said release button hook arm is shaped like a j.

6. The system of claim 5 wherein said release button hook arm interacts with the support pin locking clip face in order to pull the hook release button hook out of the release button hook groove.

7. The system of claim 6 wherein said release button hook arm interacts within the support pin release button shaft region when the button is locked down.

8. The system of claim 7 wherein said release button hook arm interacts above the support pin anchor shaft during insertion as in the anchor shaft traversal system.

9. The system of claim 8 wherein said release button hook arm is positioned above the support pin anchor shaft during removal as in the support pin removal system.

10. The system of claim 9 wherein said release button hook arm is positioned central to release button front guide rail.

11. The system of claim 10 wherein said cube comprises cube teeth wherein the cube teeth are configured to secure, in concert with an opposing cube teeth on the opposite side of a cube circle face, a beam in an axis plane.

12. The system of claim 11 wherein the hook comprises a hook release button hook wherein the hook release button hook is positioned near the release button hook groove in order to keep the #release button in a locked down and open position.

13. The system of claim 12 wherein said release button hook arm can flex like a spring.

14. The system of claim 13 wherein said release button hook arm is shaped like a j.

15. The system of claim 14 wherein said release button hook arm interacts with the support pin locking clip face in order to pull the hook release button hook out of the release button hook groove.

16. The system of claim 15 wherein said release button hook arm interacts within the support pin release button shaft region when the button is locked down.

17. The system of claim 16 wherein said release button hook arm interacts above the support pin anchor shaft during insertion as in the anchor shaft traversal system.

18. The system of claim 17 wherein said release button hook arm is positioned above the support pin anchor shaft during removal as in the support pin removal system.

19. The system of claim 18 wherein said release button hook arm is positioned central to release button front guide rail

20. The system of claim 19 wherein the hook comprises a hook release button main channel configured to guide the release button hook arm close to the hook release button hook.

21. The system of claim 20 wherein the hook comprises a hook release button floor configured to prevent the release button from going to far downwards when in use.

22. The system of claim 21 wherein the release button comprises a release button rear guide rail configured to aid the release button in providing stable vertical actuation when in use.

23. The system of claim 22 wherein the key comprises a key release button hook arm channel wherein said release button hook arm channel is configured to provide space for the release button hook arm and its vertical actuation.

24. The system of claim 23 wherein said key comprises a key release button guide channel wherein said key release button guide channel configured to allow actuation of the release button vertically.

25. The system of claim 24 wherein said locking system comprises a support attachment system wherein the support attachment system is configured to allow the cube teeth and the support teeth receiving region combine along with the cube circle face and support circle to stabilize the beam in the correct orientation.

26. The system of claim 25 wherein the cube comprises a plurality of cube teeth wherein the cube teeth is configured to secure, in concert with an opposing cube teeth on the opposite side of a cube circle face, a beam in an axis plane.

27. The system of claim 26 wherein the cube comprises a cube circle face wherein the cube circle face configured to interact with the support circle to form a tight seal when assembled and locked to provide stability to a joint.

28. The system of claim 27 wherein the support comprises a support circle wherein the support circle is configured to interact with the cube circle face to provide stable support.

29. The system of claim 28 wherein the support comprises a support transition face wherein the support transition face is configured to create a transition for interaction with the cube teeth.

30. The system of claim 29 wherein support channel cutaway wherein the support channel cutaway is configured to aid the cube teeth to structurally bind to the support.

31. The system of claim 30 wherein: the locking system comprises a locking support system;
wherein the locking support system is configured to lock the beam to the cube by having the locking clip collapse onto the support pin release button shaft so that the support pin locking clip face now prevents the support pin from being pulled out of the beam.

32. The system of claim 31 wherein the locking sub assembly is configured to comprise a locking clip;
wherein the locking clip is configured to configured to act as spring to maintain the release button in the popped up stat;
wherein the locking clip is configured to configured to allow the passage of the support pin through its middle region when the locking clip is flexed;
wherein the locking clip is configured to act as a gate when contracted to lock the support pin and stabilize the attachment of the cube to the beam.

33. The system of claim 32 wherein the support pin comprises a support pin locking clip face;
wherein the support pin locking clip face is configured to provide the barrier to prevent the locking clip from sliding essentially locking the beam to the cube;
wherein the support pin locking clip face is configured to serves to lock the beam to the support pin when the locking clip collapses onto the support pin release button shaft.

34. The system of claim 33 wherein the key comprises a key locking clip foundation slot wherein the key locking clip foundation slot is configured to receive and orient the locking clip in a vertical position.

35. The system of claim 34 wherein the support pin comprises a support pin release button shaft wherein the support pin release button shaft is configured to receive the release button hook arm into its region when the release button is in its locked open state.

36. The system of claim 35 wherein the support pin comprises a support pin main shaft wherein the support pin main shaft is configured to provide the main structural support for the support pin.

37. The system of claim 36 wherein the key comprises a key locking clip spacer wherein the key locking clip space is configured to provide space for the width of the locking clip.

38. The system of claim 37 wherein the release button comprises a release button locking clip retainer wherein the release button locking clip retainer is configured to keep the locking clip in the proper position while in use.

39. The system of claim 38 wherein the disassembly system comprises a release button pop up system wherein the release button pop up system is configured to release the release button from its locked open state and popping up the button because the locking clip spring has forced it up.

40. The system of claim 39 wherein the furniture locking assembly system comprises a release button reset system wherein the release button reset system is configured to ensure that the release button is unlocked and reset, by having the support pin locking clip front taper pushing up the release button hook arm via the release button support pin groove which releases the hook release button hook from the release button hook groove.

41. The system of claim 40 wherein the release button hook arm interacts with the support pin in order to reset the release button according to the release button reset system.

42. The system of claim 41 wherein the release button comprises a release button support pin groove wherein the release button support pin groove is configured to interact with the support pin in order to help reset a depressed button as in the release button reset system.

43. The system of claim 42 wherein the support pin comprises a support pin locking clip taper wherein the support pin locking clip taper is configured to serve as a guide to help orient the support 45. pin and also expand the locking clip when a support pin is inserted.

44. The system of claim 43 wherein the support pin comprises a support pin locking clip front taper wherein the support pin locking clip taper is configured to serve as a means to create tolerance for the accuracy of insertion of the support pin into the support tube.

45. The system of claim 44 wherein the support pin locking clip taper comprises a support pin locking clip back taper wherein the support pin locking clip back taper is configured to expand the locking clip when the support pin is pushed in, when assembling the furniture.

46. The system of claim 45 wherein comprises a hook arm catch system wherein the unlock all furniture system is configured to allow for the hook release button hook to catch on the release button hook groove which keeps the release button depressed and the locking clip expanded.

47. The system of claim 46 wherein the release button comprises a release button hook groove wherein the release button hook groove is configured to release button hook groove interact with the hook release button hook to lock the release button in the down position.

48. The system of claim 47 wherein the release button hook groove shape and depth substantially matches that of the hook release button hook.

49. The system of claim 48 wherein the release button hook groove interacts with the hook release button hook during implementation of the locking system.

50. The system of claim 49 wherein the release button hook groove positioned on the release button hook arm.

51. The system of claim 50 wherein the release button hook groove is positioned opposing the hook release button hook.

52. The system of claim 51 wherein the locking system comprises a axis orientation guidance system wherein the axis orientation guidance system is configured to guide the beam to the right roll, yaw and pitch position by the cube transition wedge as the support pin travels further into the beam

53. The system of claim 52 wherein the cube comprises a cube transition wedge wherein the cube|transition wedge is configured to guide the four support holding arm into a proper axis for beam attachment.

54. The system of claim 53 wherein the support comprises a support holding arm wherein the support holding arm is configured to interact with the axis orientation guidance system in order to put the beam in the proper axis during assembly

55. The system of claim 54 wherein the support comprises a support tube cutout wherein the support tube cutout is configured to interact with the key support tube cutout in order to properly orient the support when it is attached to the beam.

56. The system of claim 55 wherein the key comprises a key support tube cutout wherein the key support tube cutout is configured to interact with the support tube to provide proper orientation of the support during assembly.

57. The system of claim 56 wherein the locking system comprises a anchor shaft traversal system wherein the anchor shaft traversal system is configured to guide the support pin further into the depth of the beam allowing for the subsequent correct orientation as mediated by the axis orientation guidance system and allowing for the locking clip to be used to lock the beam to the cube once the proper axes are established

58. The system of claim 57 wherein the support pin comprises a support pin anchor shaft wherein the support pin anchor shaft is configured to serve as a traversal path for the locking clip to allow for attachment of the cube teeth to the support teeth receiving region stabilizing the attachment

59. The system of claim 58 wherein the disassembly system comprises a hook arm removal system wherein the hook arm removal system is configured to force the hook release button hook out of release button hook groove because the support pin locking clip face pulled the release button hook arm

60. The system of claim 59 wherein the disassembly system comprises a support pin removal system wherein the support pin removal system is configured to allow the the cube to be pulled apart from the beam while the release button is locked down allowing the locking clip back over the support pin anchor shaft allowing removal of the support pin

61. The system of claim 60 wherein the furniture locking assembly system comprises a locking clip expansion system wherein the locking clip expansion system is configured to expand the locking clip by having the the support pin locking clip back taper physically widen the locking clip as the support pin is pushed through the center of the locking clip.

62. The system of claim 61 wherein the furniture locking assembly system comprises a pin insertion system;
wherein the pin insertion system is configured to push the support pin into the support tube until the support pin locking clip taper enters the locking sub assembly;
wherein the pin insertion system comprises a support tube;
wherein the support tube configured to guide the support pin to the locking sub assembly;
wherein the pin insertion system comprises a hook support pin hole;
wherein the support pin hole is configured to allow the support pin to pass through.

63. The system of claim 62 wherein the furniture locking assembly system comprises a cube orientation system wherein the orientation system is configured to orient the support pin in front of the support tube so that it can be inserted into the beam.
